(19) United States
(12) Patent Application Publication
(10) Pub. No.: US 2026/0039445 A1
(43) Pub. Date: Feb. 5, 2026

(54) METHODS FOR INTER-CARRIER SBFD CONFIGURATIONS

(71) Applicant: InterDigital Patent Holdings, Inc., Wilmington, DE (US)

(72) Inventors: Jonghyun Park, Syosset, NY (US); Nazli Khan Beigi, Longueuil (CA); Moon IL Lee, Melville, NY (US); Aata EI Hamss, Laval (CA); Virgile Garcia, Antibes (FR)

(73) Assignee: InterDigital Patent Holdings, Inc., Wilmington, DE (US)

(21) Appl. No.: 18/794,475

(22) Filed: Aug. 5, 2024

(51) Int. Cl. H04L 5/14; H04W 24/08; H04W 72/0446; H04W 72/0453

(52) U.S. Cl. CPC H04L 5/14; H04W 24/08; H04W 72/0446; H04W 72/0453

(57) ABSTRACT

A method performed by a WTRU may comprise: receiving first configuration information, including multi-cell duplexing configuration information, wherein the multi-cell duplexing configuration information indicates a first reference cell and a linked cell, wherein the first reference cell is included in a set of one or more reference cells; receiving, from a network, second configuration information comprising an inter-cell frequency gap threshold and information associated with the set of one or more reference cells; on a condition that a frequency gap between the reference cell and the linked cell is less than the inter-cell frequency gap threshold, determining, based on the received second configuration information, a SBFD configuration for the linked cell; and applying, to the linked cell, the determined SBFD configuration.

### BACKGROUND

New Radio (NR) duplex technology may improve conventional time division duplex (TDD) operation by enhancing uplink (UL) coverage, improving capacity, and reducing latency. Conventional TDD is based on splitting the time domain between the uplink and downlink. In current wireless standards, the feasibility of allowing full duplex, or more specifically, subband non-overlapping full duplex (SBFD) at the base station (e.g., gNB) within a conventional TDD band is being discussed.

In current wireless standards, the SBFD configuration is (semi-) static and is expected to be the same across different neighboring cells. 6th Generation or future NR releases may introduce dynamic configuration of SBFD (e.g., by allowing dynamic changes of configuration for each cell and/or WTRU specific configuration using flexible SBFD slots/symbols).

### SUMMARY

A method performed by a WTRU, may comprise: receiving first configuration information, including multi-cell duplexing configuration information, wherein the multi-cell duplexing configuration information indicates a first reference cell and a linked cell, wherein the first reference cell is included in a set of one or more reference cells; receiving, from a network, second configuration information comprising an inter-cell frequency gap threshold and information associated with the set of one or more reference cells; on a condition that a frequency gap between the reference cell and the linked cell is less than the inter-cell frequency gap threshold, determining, based on the received second configuration information, a subband non-overlapping full duplex (SBFD) configuration for the linked cell; and applying, to the linked cell, the determined SBFD configuration.

The first configuration information may further include at least one of: duplexing information for all time resources associated with the reference cell and the linked cell or frequency information associated with the reference cell and the linked cell. The frequency information may include at least one of a frequency position and size of a carrier, subband, or bandwidth part.

The second configuration information may include at least one of: duplexing information for one or more time resources associated with the reference cell or frequency information associated with the reference cell. The second configuration information may include an indication of time resources to be configured in the reference cell, including duplexing directions. The determination of the SBFD configuration for the linked cell is for the time resources may be included in the second configuration information. The time resources of the linked cell are configured as flexible, SBFD, or flexible SBFD. Applying the determined SBFD configuration may include at least one of: performing uplink transmissions on an uplink subband in the time resources indicated in the second configuration information; or monitoring downlink transmissions on an downlink subband in the time resources indicated in the second configuration information. The determined SBFD configuration includes a number of subbands and a duplex direction for each subband. The duplex direction for the subband adjacent to the reference cell is the same as a duplex direction of the reference cell.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an example of inter-base stations and inter-WTRUs cross link interference (CLI);

FIG. 3 is an example of inter-subband and inter-carrier leakage interference cases where the UL transmission in an adjacent frequency carrier;

FIG. 4 is an example SBFD configuration;

FIG. 5. is an example of SBFD patterns configured to be selected by a linked cell based on a single reference cell;

FIG. 6 is an example of SBFD patterns configured to be selected by the linked cell based on two reference cells;

FIG. 7 is an example timeline where a WTRU changes its linked cell SBFD configuration based on the reference cell;

FIG. 8 is an example where a WTRU is configured with a linked cell that is associated with two reference cells;

FIG. 9 is an example of a WTRU changing a subband based on a reference cell reconfiguration;

FIG. 10 is an example procedure performed by a WTRU; and

FIG. 11 is an example of sets of linked cell SBFD configurations listed for different reference cells configuration.

### DETAILED DESCRIPTION

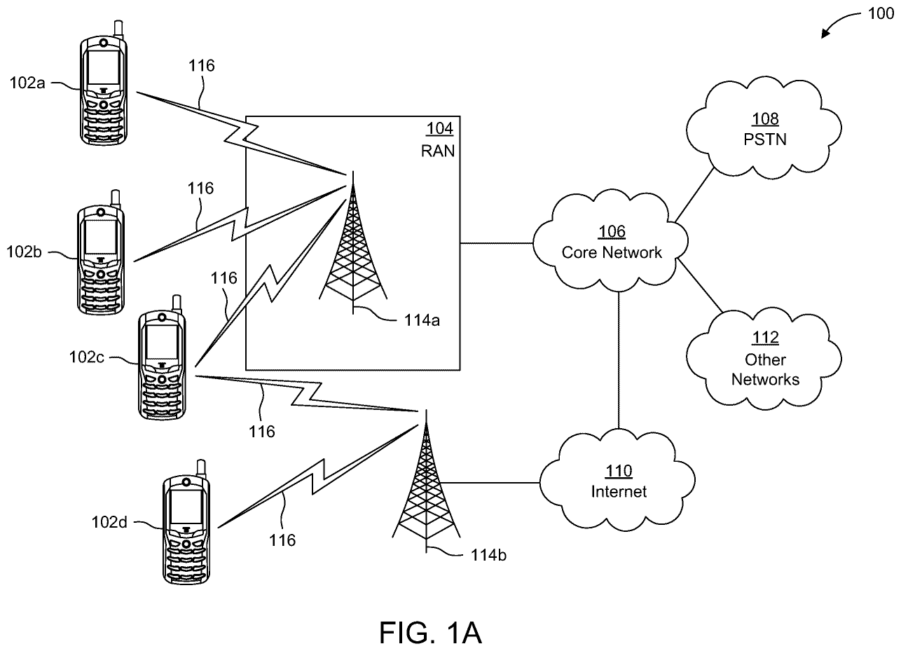

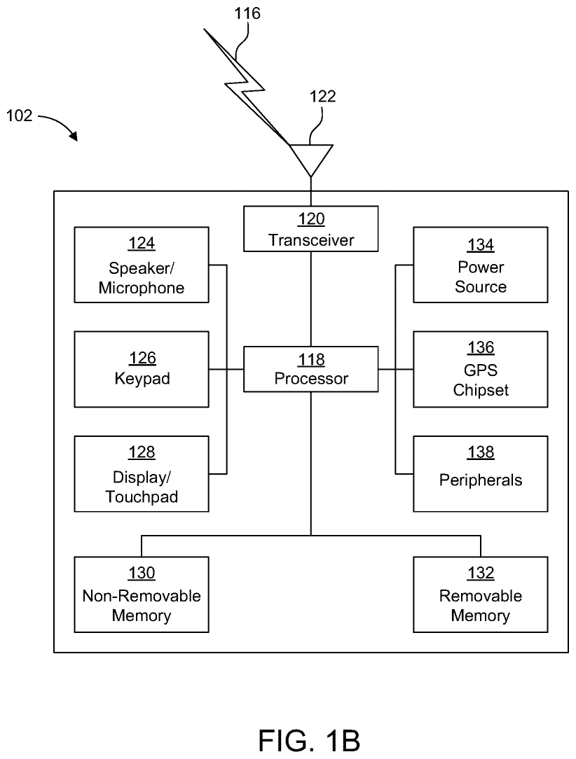

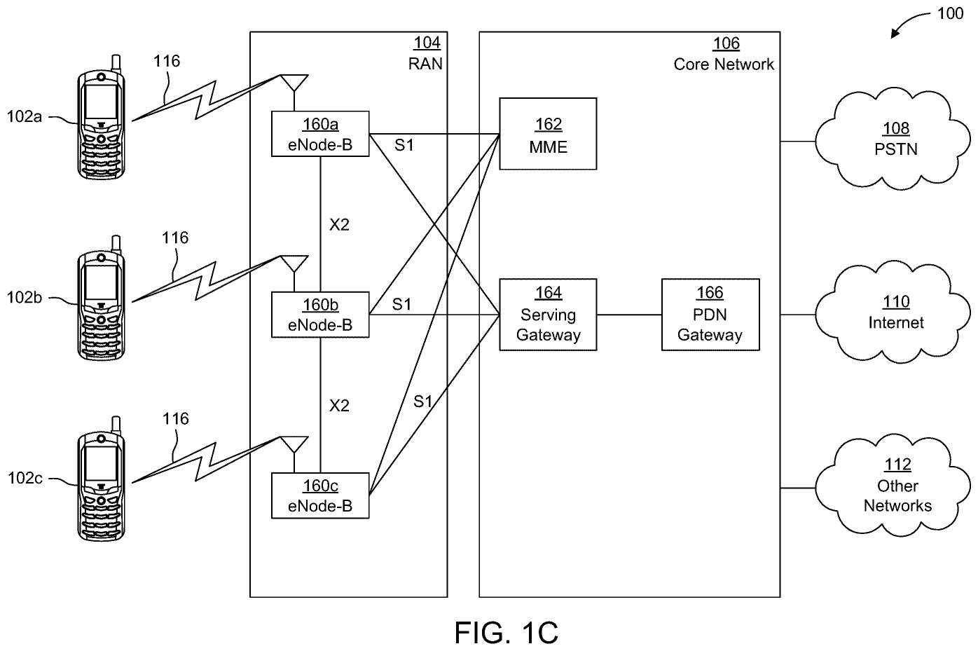

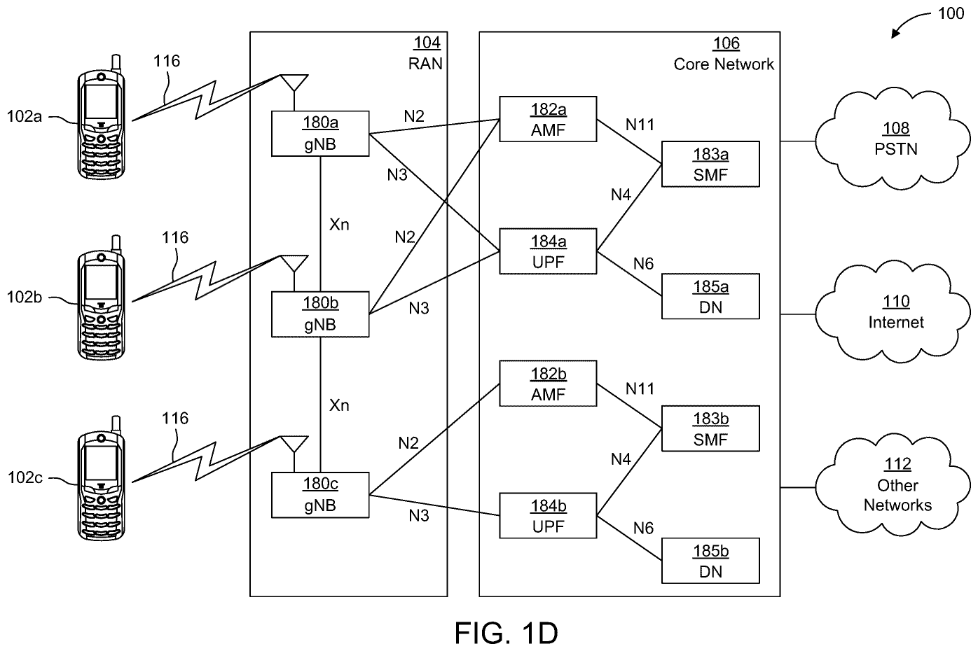

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms may be referred to:
ACK Acknowledgement
BLER Block Error Rate
BS Base Station
BWP Bandwidth Part
CA Carrier Aggregation
CAP Channel Access Priority
CAPC Channel access priority class
CCA Clear Channel Assessment
CCE Control Channel Element
CE Control Element
CG Configured grant or cell group
CLI Cross Link Interference
CP Cyclic Prefix
CP-OFDM Conventional OFDM (relying on cyclic prefix)
CQI Channel Quality Indicator
CRC Cyclic Redundancy Check
CSI Channel State Information
CW Contention Window
CWS Contention Window Size
CO Channel Occupancy
DAI Downlink Assignment Index
DCI Downlink Control Information
DFI Downlink feedback information
DG Dynamic grant
DL Downlink
DM-RS Demodulation Reference Signal
DRB Data Radio Bearer
eLAA enhanced Licensed Assisted Access
FD Full Duplex
FeLAA Further enhanced Licensed Assisted Access
HARQ Hybrid Automatic Repeat Request
HD Half Duplex
LAA License Assisted Access
LBT Listen-Before-Talk
LI Layer Index
LTE Long Term Evolution e.g. from 3GPP LTE R8 and up
MAC CE MAC control element
MCS Modulation and Coding Scheme
MIMO Multiple Input Multiple Output
NACK Negative ACK
NR New Radio
OFDM Orthogonal Frequency-Division Multiplexing
PDCCH Physical Downlink Control Channel
PDSCH Physical Downlink Shared Channel
PHY Physical Layer
PID Process ID
PMI Precoding Matrix Indicator
PO Paging Occasion
PUCCH Physical Uplink Control Channel
PUSCH Physical Uplink Shared Channel
PRACH Physical Random Access Channel
PRB Physical Resource Block
PSS Primary Synchronization Signal
RA Random Access (or procedure)
RACH Random Access Channel
RAR Random Access Response
RB Resource Block
RCU Radio access network Central Unit
RF Radio Front end
RI Rank Indicator
RLF Radio Link Failure
RLM Radio Link Monitoring
RNTI Radio Network Identifier
RO RACH occasion
RRC Radio Resource Control
RRM Radio Resource Management
RS Reference Signal
RSRP Reference Signal Received Power
RSSI Received Signal Strength Indicator
SBFD Subband Full Duplex
SDU Service Data Unit
SI Self Interference
SRS Sounding Reference Signal
SS Synchronization Signal
SSB Synchronization Signal Block
SSBRI SSB Resource Indicator
SSS Secondary Synchronization Signal
SWG Switching Gap (in a self-contained subframe)
SPS Semi-persistent scheduling
SRI SRS Resource Indicator
SUL Supplemental Uplink
TB Transport Block
TBS Transport Block Size
TCI Transmission Configuration Indicator
TDD Time Division Duplex
TRP Transmission/Reception Point
TSC Time-sensitive communications
TSN Time-sensitive networking
UCI Uplink Control Information
UE User Equipment
UL Uplink
Ultra-Reliable and Low Latency Communications URLLC
WBWP Wide Bandwidth Part
WTRU Wireless Transmit/Receive Unit
WLAN Wireless Local Area Networks and related technologies (IEEE 802.xx domain)
XDD Cross Division Duplex

New Radio (NR) duplex technology may improve conventional TDD operation by enhancing UL coverage, improving capacity, reducing latency, and so forth. The conventional TDD is based on splitting the time domain between the uplink and downlink. In current wireless standards, the feasibility of allowing full duplex, or more specifically, subband non-overlapping full duplex (SBFD) at the gNB within a conventional TDD band is being discussed.

In current wireless standards, the SBFD configuration is (semi-) static and is expected to be the same across different neighboring cells. 6G or NR future releases may introduce dynamic configuration of SBFD (e.g., by allowing dynamic changes of configuration for each cell and/or WTRU specific configuration using flexible SBFD slots/symbols).

The realization of SBFD is subject to resolving the key challenges raised due to cross-link interferences (CLI). The CLI can be measured at both the victim and/or aggressor WTRUs. For WTRUs, the UL-to-DL CLI happens when an UL transmission from an aggressor WTRUs causes interferences at a victim WTRUs receiving DL transmissions. WTRUs may be subject to different types of UL-to-DL CLI.

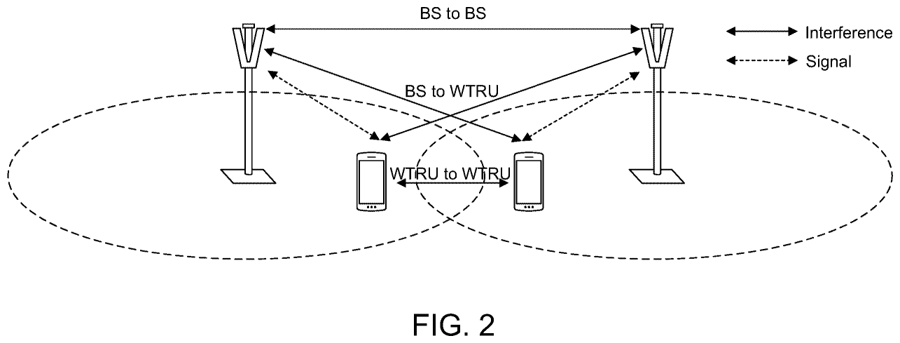

On type of UL-to-DL CLI is intra-frequency, inter-cell CLI, where neighboring cells are configured with different link directions in the same carrier frequency, either for SBFD or dynamic/flexible TDD cases. FIG. 2 illustrates an example of inter-base stations and inter-WTRUs CLI.

Another type of UL-to-DL CLI is intra-frequency, inter-subband CLI, where an UL transmission (from the serving cell or a neighboring cell) in a SBFD subband creates leakage interference in the adjacent DL subband, for the SBFD scenario.

Another type of UL-to-DL CLI is inter-frequency CLI, where the UL transmission in an adjacent frequency carrier (from the serving cell or a neighboring cell) creates leakage in the adjacent DL subband, for both SBFD and dynamic/flexible TDD scenarios.

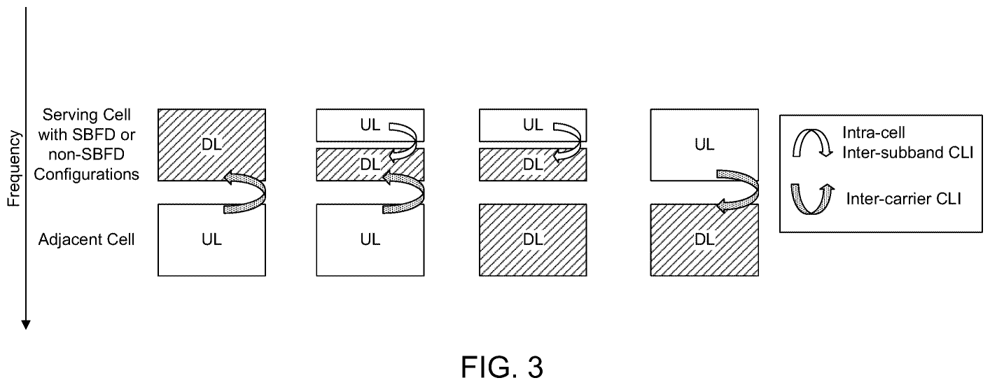

FIG. 3 illustrates exemplary inter-subband and inter-carrier leakage interference cases where the UL transmission in an adjacent frequency carrier (from the serving cell or a neighboring cell) creates leakage in the adjacent DL subband, for both SBFD and dynamic/flexible TDD scenarios.

In certain situations, multi-cells are controlled by the same gNB. For example, the network/gNB may control and know the configuration across cells on adjacent frequencies and the WTRU may be configured with carrier aggregation (CA) or may be aware of multi-cell configuration. Dynamic SBFD may be considered, where different slots/symbols may be configured with different subband configuration, and neighboring cell may be configured differently as well. One potential issue is that CLI is higher when frequency-adjacent cells use different duplexing directions, especially when the inter-cell frequency gap is small. Accordingly, it may be necessary to efficiently and dynamically configure the directions of multiple cells to reduce the CLI, especially when the inter-cell frequency gap is small.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) may be used herein to represent ‘and/or’, where for example, ‘A/B’ may imply ‘A and/or B’.

Hereinafter, the term “subband” may be used to refer to a frequency-domain resource and may be characterized by at least one of the following: a set of resource blocks (RBs); a set of RB sets (e.g., when a carrier has intra-cell guard bands); a set of interlaced resource blocks; a bandwidth part, or portion thereof; and/or a carrier, or portion thereof. For example, a subband may be characterized by a starting RB and number of RBs for a set of contiguous RBs within a bandwidth part. A subband may also be defined by the value of a frequency-domain resource allocation field and bandwidth part index.

Hereinafter, the term “XDD” may be used to refer to a subband-wise duplex (e.g., either UL or DL being used per subband) and may be characterized by at least one of the following: cross Division Duplex (e.g., subband-wise FDD within a TDD band); subband-based full duplex (e.g., full duplex as both UL and DL are used/mixed on a symbol/slot, but either UL or DL being used per subband on the symbol/slot); frequency-domain multiplexing (FDM) of DL/UL transmissions within a TDD spectrum; a subband non-overlapping full duplex (SBFD) (e.g., non-overlapped subband full-duplex) a full duplex other than a same-frequency (e.g., spectrum sharing, subband-wise-overlapped) full duplex; an advanced duplex method, (e.g., other than (pure) TDD or FDD).

Hereinafter, the term “dynamic (/flexible) TDD” may be used to refer to a TDD system/cell which may dynamically (and/or flexibly) change/adjust/switch a communication direction (e.g., a downlink, an uplink, or a sidelink, etc.) on a time instance (e.g., slot, symbol, subframe, and/or the like). In an example, In a system employing dynamic/flexible TDD, a component carrier (CC) or a bandwidth part (BWP) may have one single type among ‘D’, ‘U’, and ‘F’ on a symbol/slot, based on an indication by a group-common (GC)-DCI (e.g., format 2_0) comprising a slot format indicator (SFI), and/or based on tdd-UL-DL-config-common/dedicated configurations. On a given time instance/slot/symbol, a first gNB (e.g., cell, TRP) employing dynamic/flexible TDD may transmit a downlink signal to a first WTRU being communicated/associated with the first gNB based on a first SFI and/or tdd-UL-DL-config configured/indicated by the first gNB, and a second gNB (e.g., cell, TRP) employing dynamic/flexible TDD may receive an uplink signal transmitted from a second WTRU being communicated/associated with the second gNB based on a second SFI and/or tdd-UL-DL-config configured/indicated by the second gNB. In an example, the first WTRU may determine that the reception of the downlink signal is being interfered by the uplink signal, where the interference caused by the uplink signal may refer to a WTRU-to-WTRU cross-layer interference (CLI).

Hereinafter, the term “SBFD” may be used to refer to a subband-wise duplex (e.g., either UL or DL being used per subband) and may be characterized by at least one of the following: cross Division Duplex (e.g., XDD, subband-wise FDD within a TDD band); subband-based full duplex (e.g., full duplex as both UL and DL are used/mixed on a symbol/slot, but either UL or DL being used per subband on the symbol/slot); frequency-domain multiplexing (FDM) of DL/UL transmissions within a TDD spectrum; a subband non-overlapping full duplex (SBFD) (e.g., non-overlapped subband full-duplex); a full duplex other than a same-frequency (e.g., spectrum sharing, subband-wise-overlapped) full duplex; an advanced duplex method, for example, other than (pure) TDD or FDD, (e.g., partial in-band full duplex, subband overlapping full duplex, in-band full duplex (IBFD)).

In the following descriptions, a property of a grant or assignment may include at least one of the following: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); any parameter provided in a DCI, by MAC or by RRC for the scheduling the grant or assignment.

In the following descriptions, an indication by DCI may include at least one of the following: an explicit indication by a DCI field or by RNTI used to mask CRC of the PDCCH and/or an implicit indication by a property such as DCI format, DCI size, CORSET or search space, aggregation level, first resource element of the received DCI (e.g., index of first Control Channel Element), where the mapping between the property and the value may be signaled by RRC or MAC.

Hereinafter, a signal may be interchangeably used with one or more of following: sounding reference signal (SRS); channel state information-reference signal (CSI-RS); demodulation reference signal (DMRS); phase tracking reference signal (PT-RS); and/or synchronization signal block (SSB).

Hereinafter, a channel may be interchangeably used with one or more of following: physical downlink control channel (PDCCH); physical downlink shared channel (PDSCH); physical uplink control channel (PUCCH); physical uplink shared channel (PUSCH); physical random access channel (PRACH).

Hereinafter, downlink reception may be used interchangeably with Rx occasion, PDCCH, PDSCH, SSB reception, but still consistent with this invention. Hereinafter, uplink transmission may be used interchangeably with Tx occasion, PUCCH, PUSCH, PRACH, SRS transmission, but still consistent with this invention. Hereinafter, RS may be interchangeably used with one or more of RS resource, RS resource set, RS port and RS port group, but still consistent with this invention. Hereinafter, RS may be interchangeably used with one or more of SSB, CSI-RS, SRS and DM-RS, but still consistent with this invention. Hereinafter, time instance may be interchangeably used with slot, symbol, subframe, but still consistent with this invention.

Hereinafter, UL-only and DL-only Tx/Rx occasions may interchangeably be used with legacy TDD UL or legacy TDD DL, respectively, and still consistent with this disclosure. In an example, the legacy TDD UL/DL Tx/Rx occasions may be the cases where SBFD is not configured and/or where SBFD is disabled. Hereinafter, a UL signal (e.g., at least one of SRS, DMRS, PUSCH, PUCCH, PRACH, PTRS, etc.) may be used interchangeably with a UL signal or channel, or a UL channel or signal, but still consistent with this invention. Hereinafter, a DL signal (e.g., at least one of CSI-RS, SSB, PDSCH, PDCCH, PBCH, PTRS, etc.) may be used interchangeably with a DL signal or channel, or a DL channel or signal, but still consistent with this invention.

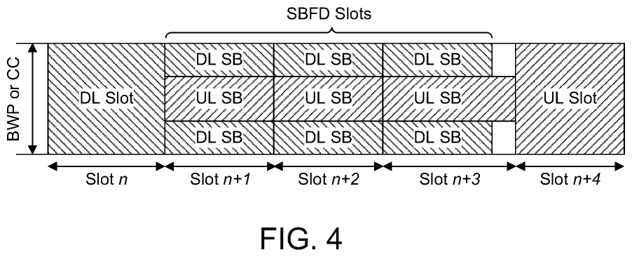

FIG. 4 illustrates an exemplary SBFD configuration. As shown in FIG. 4, a WTRU may be configured with one or more types of slots within a bandwidth, wherein a first type of slot may be used or determined for a first direction (e.g., downlink, or sidelink (e.g., device-to-device communication)); a second type of slot may be used or determined for a second direction (e.g., uplink, or sidelink); a third type of slot may have a first group of frequency resources within the bandwidth for a first direction and a second group of frequency resources within the bandwidth for a second direction. Herein, the bandwidth may be interchangeably used with bandwidth part (BWP), carrier, subband, and system bandwidth; the first type of slot (e.g., the slot for a first direction) may be referred to as downlink (and/or sidelink) slot; the second type of slot (e.g., slot for a second direction) may be referred to as uplink (and/or sidelink) slot; the third type of slot may be referred to as Subband (non-overlapping or overlapping) Full Duplex (SBFD) slot, for example, comprising at least one of DL SB(s), UL SB(s), sidelink SB(s), guard band(s) (or RB(s)), and flexible SB(s)) (e.g., SB(s) that may be dynamically determined as one of DL SB(s), UL SB(s), sidelink SB(s)); the group of frequency resource for a first direction may be referred to as downlink (and/or sidelink) subband, downlink (and/or sidelink) frequency resource, or downlink (and/or sidelink) RBs; the group of frequency resource for a second direction may be referred to as uplink (and/or sidelink) subband, uplink (and/or sidelink) frequency resource, or uplink (and/or sidelink) RBs; the group of frequency resource for a flexible direction (e.g., that can be configured for a first direction, second direction, etc.) may be referred to as flexible subband, flexible frequency resource, or flexible RBs; the group of frequency resource between a first direction and a second direction may be referred to as guard band, guard frequency resource, or guard RBs.

In an example, a (SBFD-enabled) WTRU may receive configuration information or be configured with one or more SBFD UL, DL, sidelink, flexible, and/or guard subbands in one or more DL/UL/flexible TDD time instances (e.g., symbols, slots, frames, and so forth). The WTRU may be configured with one or more resource allocations for SBFD subbands.

For example, the SBFD configuration may include a flag signal (e.g., enabled/disabled), where for example a first value (e.g., zero (0)) indicates a first mode of operation (e.g., SBFD configuration), and a second value (e.g., one (1)) may indicate a second mode of operation (e.g., non-SBFD operation). The modes of operation (e.g., SBFD and/or non-SBFD) may be indicated via MIB, SIB, RRC, MAC-CE, and/or DCI.

The WTRU may receive the time resources (e.g., one or more symbols, slots, and so forth), for which the first mode of operation (e.g., SBFD) is defined in for example one or more BWPs, subbands, component carriers (CC), cells, and so forth. The WTRU may receive the frequency resources (e.g., subbands/BWPs including one or more PRBs) within (active and/or linked) BWP, for which the first mode of operation (e.g., SBFD) is configured. The time instances (e.g., slots, symbols) may be indicated based on periodic, semi-persistent, or aperiodic type configurations. In an example, the time instances may be indicated via a bitmap configuration, where each bit corresponds to a time instance (e.g., slot, symbol, subframe, etc.) and each bit indication indicates whether corresponding time instance can be used for the first or second mode of operation.

In an example, a WTRU may be configured with a DL TDD configuration for a component carrier (CC) or a BWP for one or more Rx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., subbands, PRBs, and/or BWPs) may be configured for the transmission in UL channels and/or Tx occasions.

In another example, the WTRU may be configured with an UL TDD configuration for a component carrier (CC) or a BWP for one or more Tx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., subbands, PRBs, and/or BWPs) may be configured as the DL channels and/or Rx occasions.

In another example, the WTRU may be configured with a DL, UL, or Flexible TDD configuration for a component carrier (CC) or a BWP for one or more Rx/Tx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., subbands, PRBs, and/or BWPs) may be configured for the first mode of operation (e.g., either UL transmission or DL reception based on the configurations).

The duplexing mode for the first mode of operation (e.g., SBFD configuration (UL/DL)) may be indicated via a flag indication, where for example a first value (e.g., zero (0)) may indicate a first direction (e.g., UL duplexing mode), and a second the value (e.g., one (1)) may indicate a second direction (e.g., DL duplexing model).

The duplexing mode configuration and/or flag for the first mode of operation (e.g., SBFD) may be configured as part of modes of operation configuration, for example via MIB, SIB, RRC, DCI, and/or MAC-CE.

The duplexing mode configuration and/or flag for the first mode of operation (e.g., SBFD) may be configured as part of resource allocation configuration for a Tx/Rx occasion.

In an example, a WTRU may be configured with one or more types of slots. The WTRU may be configured with a first slot with a first type, where the first type may be for example SBFD slot. The WTRU may be configured with a second slot with a second type, where the second type may be for example non-SBFD slot. As for the first slot with the first type (SBFD), the WTRU may be configured with one or more DL, UL, flexible, guard, etc. subbands in the frequency domain, throughout the BWP, for the duration of the first slot. However, in the second slot with the second type (non-SBFD), the WTRU may be configured with only one direction type, for example DL, UL, flexible, etc., in the frequency domain, throughout the BWP, for the duration of the second slot.

In an example, if the WTRU is configured with a second slot with UL direction, this implies legacy TDD UL slot, UL-only slot, and/or non-SBFD UL slot. In another example, if the WTRU is configured with a third slot with second type (non-SBFD) with DL direction, this implies legacy TDD DL slot, DL-only slot, and/or non-SBFD DL slot. In another example, if the WTRU is configured with a fourth slot with second type (non-SBFD) with flexible direction, this implies legacy TDD flexible slot and/or non-SBFD flexible slot, and so forth.

In an example, the WTRU may be configured with a SBFD ‘DU’ configuration, referring to a configuration where the upper-frequency subband of the cell's carrier is configured as a Downlink subband, while the lower-frequency subband of the same cell's carrier is configured as an Uplink subband. One or more guard-band (i.e., unused frequency resources) may be configured at the edge of the cell's carrier or in between subbands.

In an example, the WTRU may be configured with a SBFD ‘UD’ configuration, referring to a configuration where the upper-frequency subband of the cell's carrier is configured as an Uplink subband, while the lower-frequency subband of the same cell's carrier is configured as a Downlink subband. One or more guard-band (i.e., unused frequency resources) may be configured at the edge of the cell's carrier or in between subbands.

In an example, the WTRU may be configured with a SBFD ‘DUD’ configuration, referring to a configuration with three subbands and both the upper-frequency and lower-frequency subband of the cell's carrier is configured as Downlink subbands, while the middle-frequency subband of the same cell's carrier is configured as an Uplink subband. One or more guard-band (i.e., unused frequency resources) may be configured at the edge of the cell's carrier or in between subbands.

In an example, the WTRU may be configured with a SBFD ‘UDU’ configuration, referring to a configuration with three subbands and both the upper-frequency and lower-frequency subband of the cell's carrier is configured Uplink subbands, while the middle-frequency subband of the same cell's carrier is configured as a Downlink subband. One or more guard-band (i.e., unused frequency resources) may be configured at the edge of the cell's carrier or in between subbands.

A WTRU may receive configurations of (e.g., may be configured with) SBFD subband time locations that may be configured within a period. In an example, the period may be the same as TDD-UL-DL pattern period configured by dl-UL-TransmissionPeriodicity, (e.g., in TDD-UL-DL-ConfigCommon). The period may be an integer multiple of TDD-UL-DL pattern period configured by dl-UL-TransmissionPeriodicity, for example, in TDD-UL-DL-ConfigCommon.

When a TDD-UL-DL pattern is configured, SBFD symbols may be configured in consecutive manner within a TDD-UL-DL pattern period. When two TDD-UL-DL patterns are configured and if SBFD symbols are configured for only one of the patterns, SBFD symbols may be configured in consecutive manner within the TDD-UL-DL pattern period. When two TDD-UL-DL patterns are configured and if SBFD symbols are configured for both patterns, SBFD symbols may be configured in consecutive manner within each TDD-UL-DL pattern period.

A WTRU may be configured with one or more SBFD configurations, changing over time. The WTRU may receive multiple configurations for different SBFD patterns, such as one or more DU, UD, DUD or UDU patterns. The WTRU may receive the configuration to apply a time pattern where different of these SBFD configurations are used over time. In an example, the period may be the same as TDD-UL-DL pattern period configured by dl-UL-TransmissionPeriodicity (e.g., in TDD-UL-DL-ConfigCommon). In an another example, the period may be an integer multiple of TDD-UL-DL pattern period configured by dl-UL-TransmissionPeriodicity, for example, in TDD-UL-DL-ConfigCommon.

A WTRU may determine (or be indicated/configured with) that ‘UL usable PRBs’ are a part of UL subband frequency resources within an UL BWP (e.g., an active UL BWP, a currently active UL BWP), and ‘DL usable PRBs’ are a part of DL subband frequency resources within an DL BWP (e.g., an active DL BWP, a currently active DL BWP). The UL usable PRBs may be determined as an intersection between a configured or indicated UL subband and an active UL BWP in SBFD symbols (and/or slots). The DL usable PRBs may be determined as an intersection between a configured or indicated DL subband(s) and an active DL BWP in SBFD symbols (and/or slots). The UL and/or DL usable PRBs may be explicitly configured within active UL and/or DL BWP, for example, in SBFD symbols and/or slots.

In an example, a WTRU may receive information on frequency resource allocation (e.g., Type 0 as RBG-level bitmap-based resource assignment) for a PDSCH or PUSCH (as being scheduled) in a slot(s). When an assigned RBG overlaps with a subband boundary, the WTRU may determine that (only) the PRBs within DL usable PRBs are to be valid for PDSCH reception and (only) the PRBs within UL usable PRBs are to be valid for PUSCH transmission, (e.g., where this may imply “partial RBG” is allowed and valid for resource allocation).

A WTRU may be configured with dedicated SBFD configuration, where the WTRU receives (e.g., via RRC dedicated signaling), the SBFD configuration to apply on selected time resources. The configuration may apply the same pattern and periods as the RRC (re) configuration TDD-UL-DL-ConfigDedicated field.

A WTRU may be configured with multiple (serving) cells (e.g., for carrier aggregation), and in the case of dynamic SBFD configuration, the WTRU may be configured with different SBFD configuration at the same time across different cells. In dynamic SBFD, neighboring cells may be configured with different SBFD directions and/or patterns.

A WTRU may determine (or be indicated/configured with) that ‘UL usable PRBs’ are a part of UL subband frequency resources within an UL BWP (e.g., an active UL BWP, a currently active UL BWP), and ‘DL usable PRBs’ are a part of DL subband frequency resources within an DL BWP (e.g., an active DL BWP, a currently active DL BWP). The UL usable PRBs may be determined as an intersection between a configured or indicated UL subband and an active UL BWP in SBFD symbols and/or slots. The DL usable PRBs may be determined as an intersection between a configured or indicated DL subband(s) and an active DL BWP in SBFD symbols and/or slots. The UL and/or DL usable PRBs may be explicitly configured within active UL and/or DL BWP, (e.g., in SBFD symbols and/or slots).

A WTRU may receive information on frequency resource allocation (e.g., Type 0 as RBG-level bitmap-based resource assignment) for a PDSCH or PUSCH (as being scheduled) in a slot(s). When an assigned RBG overlaps with a subband boundary, the WTRU may determine that (only) the PRBs within DL usable PRBs are to be valid for PDSCH reception and (only) the PRBs within UL usable PRBs are to be valid for PUSCH transmission, (e.g., where this may imply “partial RBG” is allowed and valid for resource allocation).

A WTRU may report a subset of CSI components, where CSI components may correspond to at least a CSI-RS resource indicator (CRI), a SSBRI, an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), CQI, PMI, layer index (LI), and/or the like.

A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, cell switching, and so forth.

A WTRU may measure and report the CSI, wherein the CSI for each connection mode may include or be configured with a CSI Report Configuration, including one or more of the following: CSI report quantity, for example, channel quality indicator (CQI), rank indicator (RI), precoding matrix indicator (PMI), CSI-RS resource indicator (CRI), layer indicator (LI), etc.; CSI report type (e.g., aperiodic, semi persistent, periodic; CSI report codebook configuration (e.g., Type I, Type II, Type II port selection, etc.; and/or CSI report frequency).

A WTRU may measure and report the CSI, wherein the CSI for each connection mode may include or be configured with a CSI-RS Resource Set, including one or more of the following CSI Resource settings: NZP-CSI-RS Resource for channel measurement; NZP-CSI-RS resource for interference measurement; CSI-IM resource for interference measurement.

NZP CSI-RS Resources, including one or more of the following: NZP CSI-RS Resource ID; periodicity and offset; QCL Info and TCI-state; resource mapping (e.g., number of ports, density, CDM type, etc.).

A WTRU may indicate, determine, or be configured with one or more reference signals. The WTRU may monitor, receive, and measure one or more parameters based on the respective reference signals. For example, one or more of the following may apply. The following parameters are non-limiting examples of the parameters that may be included in reference signal(s) measurements. One or more of these parameters may be included. Other parameters may be included.

SS reference signal received power (SS-RSRP) may be measured based on the synchronization signals (e.g., demodulation reference signal (DMRS) in PBCH or SSS). It may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals.

A CSI-RSRP may be measured based on the linear average over the power contribution of the resource elements (RE) that carry the respective CSI-RS. The CSI-RSRP measurement may be configured within measurement resources for the configured CSI-RS occasions.

A SS signal-to-noise and interference ration (SS-SINR) may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.

A CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

A received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth)

A cross-layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, and so forth). In the case where L1-CLI-RSSI is used, the WTRU does not perform L3 filtering over multiple measurement samples, which may help identify time bursts of interferences.

A sounding reference signals RSRP (SRS-RSRP) may be measured based on the linear average over the power contribution of the resource elements (RE) that carry the respective SRS. In the case where L1-SRS-RSRP is used, the WTRU does not perform L3 filtering over multiple measurement samples, which may help identify time bursts of interferences.

A WTRU may receive configuration information (e.g., from a gNB, a node, or a device) for full-duplex (FD) operation conducted by at least one device in a network. In an example, the FD operation may be conducted by a gNB (e.g., a BS, a node, a TRP, a cell). The WTRU may operate in a half-duplex (HD) mode for communicating with the gNB, where the HD mode may imply at a given time the WTRU either performs a UL transmission or a DL reception (not both simultaneously at the given time). The WTRU may (also) operate in an FD mode for communicating with the gNB, for example, if a corresponding WTRU capability signal(s) is reported to the gNB and/or the WTRU receives a confirmation signal (e.g., enabling the FD, configuring the FD mode) in response to transmitting the WTRU capability signal(s).

The FD operation may imply at a given time a transmitter (e.g., the gNB and/or the WTRU) may simultaneously transmit a first signal and receive a second signal. The FD operation may comprise a subband overlapping FD (e.g., in-band FD (IBFD)) operation where a first frequency-domain resource (e.g., RBG(s), RB(s), RE(s)) allocated for the first signal may have a full (or at least a partial) overlap with a second frequency-domain resource allocated for the second signal. The FD operation may comprise a subband non-overlapping FD (SBFD) operation where a first frequency-domain resource allocated for the first signal for example, assigned within a configured SBFD subband, (e.g., DL subband, usable DL PRBs) does not have an overlap with a second frequency-domain resource allocated for the second signal (e.g., assigned within a configured SBFD subband, e.g., UL subband, usable UL PRBs).

Hereinafter, the FD operation may comprise the SBFD operation, however the proposed solutions and processes may equally (or equivalently or extendedly, etc.) be employed for cases with other FD operation types (e.g., IBFD, etc.).

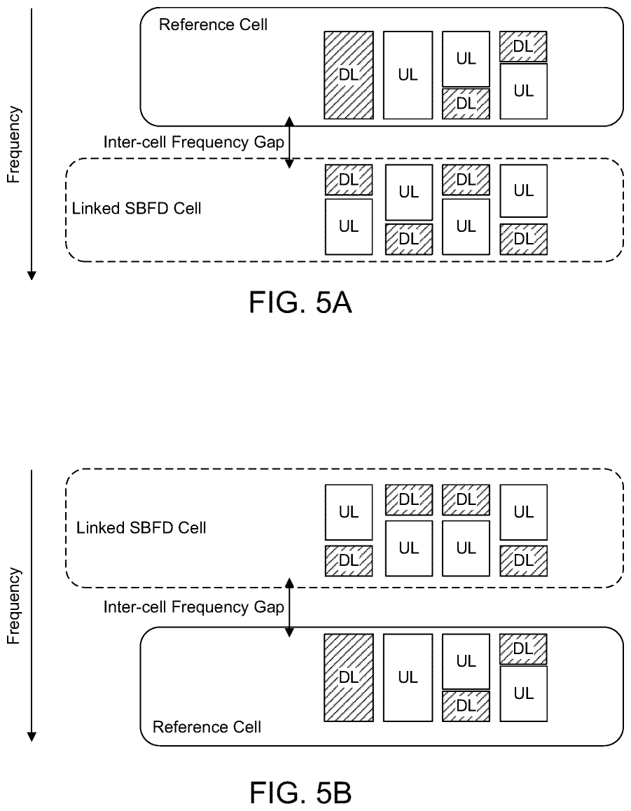

A WTRU may receive SBFD-related configuration(s), for example, for frequency-domain location information of one or more subbands (e.g., DL subband, UL subband, flexible DL/UL subband, and/or guardband), and/or for time-domain location information of the one or more subbands. The time-domain location information may indicate a set of non-SBFD symbols and a set of SBFD symbols (e.g., as illustrated in FIG. 5). A symbol(s) within the set of non-SBFD symbols may be a type of ‘DL symbol’, ‘UL symbol’ or ‘flexible symbol’. The WTRU may receive a DL signal on symbol(s) based on a type of ‘DL symbol’ in the set of non-SBFD symbols. The WTRU may transmit a UL signal on symbol(s) based on a type of ‘UL symbol’ in the set of non-SBFD symbols. The WTRU may either receive a DL signal or transmit a UL signal on symbol(s) based on a type of ‘flexible symbol’ in the set of non-SBFD symbols, (e.g., depending on one or more conditions with other signal(s) co-existing in the symbol(s)).

A WTRU may receive an indication of a (re) configuration of the duplexing directions/patterns for its configured cell(s).

For example, the WTRU may receive a SIB (SIB1) message on a cell or RRC (re) configuration indicating a duplexing (re) configuration for the different time resources of a cell, for instance, via the tdd-UL-DL-Configuration common parameter (re) configuration, (e.g., which slots and/or symbols are in the Uplink direction and which are in the downlink direction). The time resource may also be configured as flexible, where the time resource is dynamically or semi-statically configured by the network and/or given through dedicated WTRU configuration.

For example, the WTRU may receive an indication about common SBFD configuration of a cell (e.g., through SIB (e.g. SIB1) or through RRC (re) configuration). The WTRU may then be configured with slots and symbols that are either ‘DU’, ‘UD’, ‘DUD’, ‘UDU’, or regular downlink or uplink configuration.

For example, the WTRU may receive a dedicated configuration indicating an update of the duplexing direction of a cell for selected time resources (slots/symbols), (e.g., via the RRC (re) configuration TDD-UL-DL-ConfigDedicated field).

For example, the WTRU may receive an indication about dedicated SBFD configuration of a cell for selected time resources (slots/symbols), through RRC, MAC or DCI (re) configuration. The WTRU may then be configured with slots and symbols that are either ‘DU’, ‘UD’, ‘DUD’, ‘UDU’, or regular downlink or uplink configuration.

A WTRU may receive multi-carrier configuration(s), for example, where each carrier (e.g., cell, component carrier (CC), and/or a bandwidth part (BWP), etc.) is configured with a specific carrier frequency location and bandwidth. Each carrier may be configured as a cell to the WTRU, for example, referred to with a cell ID or equivalently with a carrier ID or carrier frequency information. In a typical configuration, the carriers are configured as non-overlapping with another, and a frequency gap between the carriers is ensured to avoid direct inter-carrier or inter-cell interference. However, even when the WTRU is configured with an inter-carrier gap, inter-carrier interference leakage may still be present and cause performance degradations. A WTRU may receive carrier-aggregation configuration(s) that indicates and enables the WTRU to perform transmissions and/or receptions simultaneously in different carriers/cells. The number of carrier(s) on which the WTRU may perform simultaneous transmissions and/or reception is dependent on its capabilities and is reported to the network, (e.g., based on the number of radio or the support of multiple timing advance). A WTRU may receive the Carrier(s), Multi-carrier, and Carrier-aggregation configurations and support through MIB, SIB, RRC configurations, and may further receive reconfiguration or (de) activation using RRC, MAC or DCI-based signaling.

A WTRU may receive the radio and duplexing configuration (e.g., SBFD, IBFD, or HD/TDD) for each of the carriers/cells and may be configured with aligned duplexing configuration (i.e., all the carriers have the same duplexing direction at a given time) or independent duplexing configurations (i.e., the carriers may have different duplexing direction and/or types of duplexing (e.g., SBFD vs non-SBFD).

A WTRU may receive configurations for Bandwidth Adaption in which the WTRU is configured with multiple Bandwidth Parts (BWPs). A BWP consists in a subset of the total bandwidth of a cell, (e.g., as a number and starting position of PRBs. A WTRU may have multiple BWPs configured for UL or DL. A WTRU may be configured with active BWP(s) and the (de) activation of BWPs may be following a (pre) configured time pattern or be dynamically (e.g., using DCI or MAC CE indication) signaled.

In one solution, the WTRU receives (pre) configuration to identify subband overlapping conflicts the duplexing configuration, e.g. the directions of the different time resources (slots/symbols) across multiple cells/carriers (and/or BWPs). A WTRU may determine that two frequency-adjacent cells have conflicts (e.g., unalignment, misalignment, a condition on duplex directions to be check, etc.) in their duplexing configuration, based on, for example:

In the context of non-SBFD operations, the duplexing direction of two adjacent carriers are configured in the opposite directions, (e.g., one in UL and the other in DL).

In the context of SBFD operations (or mixture or SBFD and non-SBFD operations), the subbands at the common edge of the carriers are configured in the opposite direction, including, for example: the upper-frequency cell is ‘DU’, ‘UDU’ or ‘Uplink’ while the lower-frequency cell is ‘DU’, ‘DUD’ or ‘Downlink’ and the upper-frequency cell is ‘UD’, ‘DUD’ or ‘Downlink’ while the lower-frequency cell is ‘UD’, ‘UDU’ or ‘Uplink’.

The configuration may include multiple cells, the bandwidth on which the cells operate, the duplexing direction of the different time resources, some additional conditions to consider the cells to be in conflict (see below details). The WTRU may receive an indication of a set of cells to consider for the evaluation of the duplexing conflict.

The WTRU may receive these configurations by SIB or RRC configuration, in particular for semi-static aspects of the configuration such as cells that need to be considered together, their bandwidth and their duplexing direction. The WTRU may also receive configuration some configuration via MAC CE or DCI, for more dynamic aspects, such as WTRU-specific conditions or activation of cells, applicable thresholds.

A WTRU may receive configurations for multi-cell duplexing configuration, including one or more reference cells and one or more linked cells, where a cell of one or more cells may have an indicator (e.g., linkage parameter, flag) associating to a second cell (e.g., reference cell). The reference cells are used as reference or anchor for the configuration, while the linked cells (e.g., the one or more cells) are constrained by (e.g., associated with, linked to, mapped to) the reference cells in their configuration. This means that whenever a reference cell is (re) configured, the associated linked cells may (e.g., be configured to) adapt their configuration to be compatible/aligned with their associated reference cell(s). Cells may be referred to by their cell ID, carrier frequency, component carrier, or carrier ID.

In one example, the WTRU receives a configuration for a set of cells, wherein one or more cells are indicated/labelled as reference cell while the others are indicated/labelled as linked cells. In this case, the linked/reference relationship holds within this set of cells, i.e., the WTRU considers the linked cells of this group to be constrained by the reference cells of this same group. The indications or labels may be explicitly indicated for both linked and reference cells; or may be explicitly configured/indicated/labelled for reference cells and implicitly the remaining cells are linked cells; or may be explicitly configured/indicated/labelled for linked cells and implicitly the remaining cells are reference cells;

In another example, the WTRU receives a configuration for a cell that is indicated/labelled as reference cell, and further indicating the (set of) associated linked cell(s). This way, the WTRU may determine the linked/reference relationship of the cells using the associated linked cell(s) for each of the reference cell(s).

In another example, the WTRU receives a configuration for a cell that is indicated/labelled as linked cell, and further indicating the (set of) associated reference cell(s). This way, the WTRU may determine the linked/reference relationship of the cells using the associated reference cell(s) for each of the linked cell(s).

In another example, the WTRU receives a configuration where cells are independently labelled as linked or reference cells, and the WTRU may determine the linked/reference cell relationship based on the linked or reference indication and the frequency position of each cells, (e.g., cells being frequency-adjacent may have a linked/reference relationship).

In another example, the WTRU may implicitly determine the reference or linked property of the cells based on other configurations of the cells. For example, PCell(s) (of a cell group if dual connectivity is configured) may considered as reference cells while SCells are considered as linked cells.

In one embodiment, a WTRU may receive a configuration for a linked cell, indicating which time resources may be updated based on the configuration of the reference cell.

In one example, the WTRU receives a (pre) configuration for a linked cell that all the time resources of a linked cell may be updated according to the reference cell(s). For example, this behavior is pre-defined or pre-determined as a default mode of operation (e.g., in SBFD symbols). The WTRU may receive information on a set of symbols (as being exceptional) that may be independent from the reference cell condition (e.g., keeping the current SBFD-related configuration given for the linked cell).

In one example, the WTRU receives a (pre) configuration for a linked cell that specific time resources of a linked cell may be updated according to the reference cell(s). For example, these time resources may be indicated using a binary indication for each time resources. For example, these time resources may be indicated using starting and ending time positions for resource windows. For example, the duplexing direction of these time resources may be configured as flexible, flexible SBFD, or linked.

A WTRU may receive a configuration to condition the linkage/reference relationship between cells, for example, based on a threshold on the frequency gap between the cells. The WTRU may determine or verify whether two cells are in a linked/reference relationship based on the frequency-distance between the boundaries of the carriers. This may be a complementary condition applicable in addition with the linked or reference indication for the cells.

For example, a WTRU received a configuration where one cell is a reference cell and another cell is a linked cell, and the configuration of the cells indicate their frequency occupation. The WTRU computes the distance in frequency between the two cells and determines whether the distance is greater or smaller than the configured threshold. If the gap is smaller than the threshold, the configuration of the linked cell is constrained by the configuration of the reference cell. Otherwise, if the gap is greater than the threshold, the WTRU may consider the two cells are independent (no linked/reference relationship).

In one example, the WTRU receives a single frequency gap threshold and applies the threshold to any pair of cells to verify the linked/reference relationship.

In another example, the WTRU receives a frequency gap threshold per group of multi-cell configuration, and the WTRU applies the threshold to any pair of cells within the group to verify the linked/reference relationship.

In another example, the WTRU receives multiple frequency gap thresholds, (e.g., applicable to different sets of cells based on the cell's properties, (e.g., based on their frequency bands)). For instance, the WTRU may be configured with a threshold for FR1 cells and another for FR2 cells. The WTRU then applies the threshold to any pair of cells within the corresponding applicable set of cells to verify the linked/reference relationship.

The WTRU may be (pre) configured to apply the inter-cell frequency gap threshold on one or combination of:

The frequency distance between the boundaries of the cells/carriers, for example, using the Frequency Information of the cells, including absolute center frequency, frequency bands and carrier bandwidth. This semi-static information is quite stable and only changes when the cell basic configuration change, for all the WTRUs.

The frequency distance between the boundaries of the subbands, for example, in the context of SBFD, (e.g., using the frequency location and bandwidth of the configured subbands (both UL and DL)). The subband may be configured as a subset of the carrier bandwidth (e.g., to include some guard band), considering the subband borders is relevant to evaluate the gap between cells.

The frequency distance between the boundaries of the BWPs, (e.g., using the frequency location and bandwidth of the configured BWP), relative to the cell it is configured on.

In one example, the WTRU may be (pre) configured to consider the maximum boundaries of the configured common and dedicated BWPs, whether the BWPs are active or not, e.g. the set of configured BWPs. When comparing two cells, the WTRU selects the BWPs whose border is the nearest to the compared cells, and use these border to evaluate the frequency gap and compare to the threshold.

In another example, the WTRU may be (pre) configured to consider only the active BWPs. When evaluating the frequency gap of two cells, the WTRU uses the bandwidths and positions of the active BWPs, also including the initial BWP. In the case where one of the cell is not configured with BWPs, active BWPs or only the initial BWP, the WTRU may use the boundary of the cell to compare with boundaries of the BWP of the other cell.

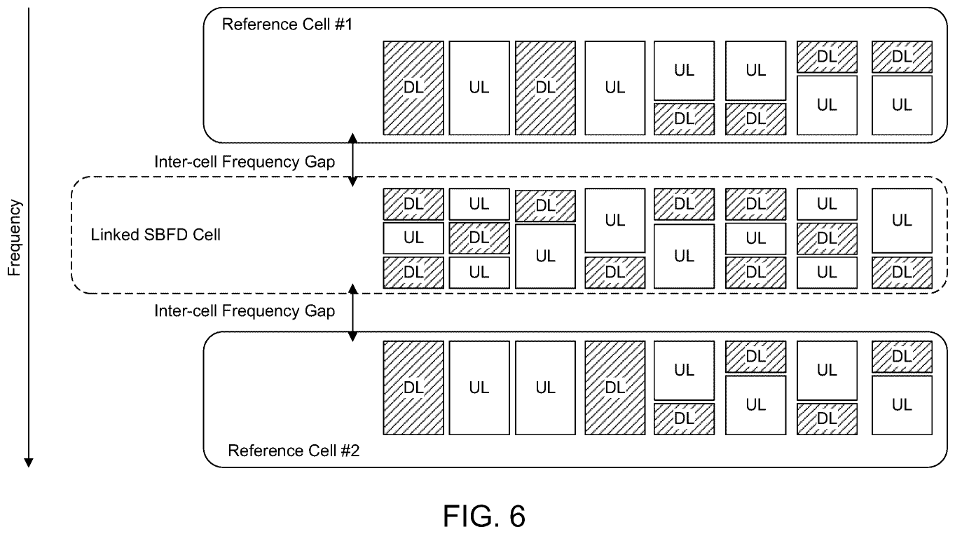

The WTRU may receive a (pre) configuration indicating the allowed linked cells SBFD configuration as a function of the reference cells duplexing directions. In one example, the WTRU may be allowed a single SBFD configuration for each possible configurations of the reference cells. Typically, the WTRU is (pre) configured so that the duplex direction of the subbands at the edge of the linked cell are in the same direction as the duplexing direction of the common edge with the reference cell, e.g., see FIG. 5 and FIG. 6. The WTRU also receives the configuration for each of these linked SBFD configuration, i.e., frequency size and positions of the subbands and/or guard bands.

For example, assuming a single frequency-adjacent reference cell, when the reference is configured to DL, the linked cell is configured as SBFD with the DL subband being on the side of adjacent to the DL reference cell, and the UL subband being configured on the other side.

For example, assuming a single frequency-adjacent reference cell, when the reference is configured to UL, the linked cell is configured as SBFD with the UL subband being on the side of adjacent to the UL reference cell, and the UL subband being configured on the other side.

For example, assuming a linked cell surrounded by two frequency-adjacent reference cells: (1) when both reference cells are configured with a DL direction, the linked SBFD cell is configured with a ‘DUD’ configuration (e.g., or ‘DUDUD’, etc. based on the number of allocated subbands); (2) when both reference cells are configured with an UL direction, the linked SBFD cell is configured with a ‘UDU’ configuration (e.g., or ‘UDUDU’, based on the number of allocated subbands); (3) when one reference cells is configured with a DL direction, and the other one is configured as a UL direction, the linked SBFD cell is configured with a ‘DU’ or ‘UD’ configuration, where the DL subband is on the side of the linked cell adjacent to the DL reference cell and the UL subband is on the side of the linked cell adjacent to the UL reference cell.

In the case where the reference cell is also a SBFD cell, the WTRU may consider the direction of subband adjacent to the linked cell as reference for the linked/reference cell relationship. For example, if the reference cell is the upper-frequency cell and is configured with ‘DU’ or ‘UDU’, the WTRU considers the reference cell constraint to be the UL subband. For example, if the reference cell is the upper-frequency cell and is configured with ‘UD’ or ‘DUD’, the WTRU considers the reference cell constraint to be the DL subband. For example, if the reference cell is the lower-frequency cell and is configured with ‘UD’ or ‘UDU’, the WTRU considers the reference cell constraint to be the UL subband. For example, if the reference cell is the lower-frequency cell and is configured with ‘DU’ or ‘DUD’, the WTRU considers the reference cell constraint to be the DL subband.

A WTRU may receive an indication of a (re) configuration of the duplexing directions/patterns for a configured linked cell. The indication may include a duplexing configuration (e.g., HD, TDD, IBFD, or SBFD) for the different time resources. The WTRU may use this duplexing configuration for the linked cell, at least as a baseline that may be updated based on reference cell's configuration (see below). In the absence of reference cell configuration, the WTRU may simply apply the received configuration as a baseline or default.

A WTRU may receive an indication of a (re) configuration of the duplexing directions/patterns for a configured reference cell, for example, via common configuration indication (SIB or RRC) or via dedicated configuration (RRC, MAC, DCI). When receiving the (re) configuration for a reference cell, the WTRU applies the duplexing configuration on that cell. In addition, the WTRU may determine and apply an update of configuration for the duplexing of an associated linked cells, if the linked cells are affected by the reference cell received (re) configuration.

The WTRU may determine the list of associated linked cells based on the received linked/reference cell configuration. The WTRU may receive a configuration that one or more linked cells are configured to be associated with that reference cell (e.g., as part of a dedicated group or based on cell configured labels). The WTRU may receive a configuration indicating a cell that is frequency-adjacent to that reference cell, and the WTRU may consider that cell as associated to or with the reference cell.

A WTRU may determine which of the associated linked cells are affected by the (re) configuration of the reference cell, by verifying if the frequency gap between the reference cell and its associated linked cell is below the configured threshold. In one example, the WTRU may use the configured threshold corresponding to the reference cell's configuration (e.g., if the cells are configured in reference/linked cells with group-specific threshold). In another example, the WTRU may use the configured threshold that corresponds to the frequency (or frequency range) of the reference/linked cell. For instance, the WTRU may be configured with two thresholds for FR1 and FR2 cells, and the WTRU uses the threshold corresponding to the configured frequency of the carriers of the cells. In one version, the WTRU checks the absolute frequency of the edge of the reference cell's carrier with the one of its associated linked cell(s) and compares the difference with the configured threshold. If the difference is smaller than the threshold, the linked cell may be considered for dynamic SBFD configuration update. In the case of dynamic SBFD, the reference cell and linked cell may not have to use the same duplexing configuration. Subbands and directions in the reference cell may be configured differently than subbands and directions in the linked cell.

In one example, the WTRU may check the gap between the SBFD subbands of the reference and its associated linked cells. The WTRU considers the subbands that are the nearest in the frequency domain across the cells. The subbands are typically configured as a subset of the frequency domain of the cell's carrier. In the situation where the subbands are dynamically configured, i.e., with time-varying configuration (not a static/semi-static configuration), the WTRU may evaluate the frequency gap between the adjacent subbands across carriers and consider the different time resources on which the gap passes the threshold and those where the threshold is not passed. The time resources where the threshold is passed may be considered for dynamic SBFD configuration update. If one of the cells does not have subband configuration or if the WTRU is not aware of it, the WTRU may use the boundary of the cell bandwidth of a cell and compare it to the boundary of the subband of another cell. The WTRU may receive an update or (re) configuration of the subbands and may re-evaluate the gap between the cells according to the received (re) configuration.

In another example, the WTRU may check the gap between the BWPs of the reference and its associated linked cells. The BWPs are typically configured as a subset of the frequency domain of the cell's carrier. In one example, the WTRU considers the BWPs that are the nearest in the frequency domain to the other cell, including all the configured BWPs (common and dedicated). The WTRU may receive an update or (re) configuration of the BWPs and may re-evaluate the gap between the cells according to the received (re) configuration. In the instance where the BWPs are dynamically planned, i.e., with time-varying configuration (not a static/semi-static configuration), the WTRU may evaluate the frequency gap between the adjacent subbands across carriers and consider the different time resources on which the gap passes the threshold and those where the threshold is not passed. The time resources where the threshold is passed may be considered for dynamic SBFD configuration update.

In another example, the WTRU considers the active BWP of the cells to evaluate the gap between the cells. Because the active BWPs are dynamically indicated (e.g., when the WTRU receives a DCI) the WTRU considers the current active BWP for and may perform re-evaluation of the gap between the cells when another BWP is activated. The WTRU may however prepare the dynamic adaption of SBFD configuration considering the inactive BWP and apply/use the one corresponding to the active BWP whenever they are activated.

In another example, the WTRU considers both the active BWP (e.g. from dedicated or common) and the common BWPs (such as the initial BWP)—since other WTRUs may be using in theses BWP in the cell. In a situation where one of the cell is not configured with BWPs or only the initial BWP, the WTRU may use the boundary of the subband or of the cell to compare with boundaries of the BWP of the other cell.

In one option, the WTRU may consider as a threshold for the frequency gap a WTRU-specific threshold, for example, based on the WTRU capabilities. WTRUs, depending on its radio and signal processing implementation, may be capable of rejecting interference and signal leakage with specific frequency masks, where different frequency distances are associated with different power loss. In one example, a WTRU with a better signal leakage rejection capability, may use a smaller frequency gap threshold. In another example, a WTRU with a poorer signal leakage rejection capability, may use a larger frequency gap threshold. The WTRU may receive the different WTRU-specific (pre) configured thresholds and apply the one corresponding to its WTRU capability. The WTRU may apply its WTRU-specific or capability-specific threshold in addition with the configured threshold for the refence/linked cell relationship.

The WTRU may determine a (sub) set of time resources of the affected associated linked cells, to only update the necessary time resources. In one example, the WTRU receives a (re) configuration of a reference cell where the whole duplexing time pattern is (re) configured, for example, receiving a common tdd-UL-DL-Configuration configuration. In that case, the WTRU may consider all the time resources to be updated. The WTRU may evaluate which of the new configuration have actually changed, by comparing the new and previous configuration, and consider for update only the time resources that have changed. In another example, the WTRU receives a (re) configuration of a reference cell where only parts of the duplexing time pattern is updated, for example, receiving a dedicated TDD-UL-DL configuration. The WTRU may only consider the time resource(s) indicated in the dedicated configuration for the linked cell configuration update. In one example, the linked cell may be (pre) configured indicating which of the time resources are to be updated based on the reference cell configuration (e.g., all the resources, selected resources or flexible resources). The WTRU may down-select the time resources based on the one configured to be updated for the linked cell.

In one option, the WTRU may be (pre) configured to only change the SBFD configuration of the linked cell when the linked cell may generate CLI to the reference cell, i.e., when an UL (sub) bands of the linked cell is adjacent to a DL (sub) band of the reference cell. The WTRU may then consider the linked cells and the corresponding (subset) of time resources where this condition is satisfied to be changed based on the reference cell. In the opposite case (i.e., an DL (sub) bands of the linked cell is adjacent to a UL (sub) band of the reference cell), the WTRU may ignore and don't consider these time resource for change. This assumes that the linked cell has a lower priority compared to the reference cell, but reduces the ‘dynamic’ changes of SBFD configuration, and the network may update the baseline configuration of the linked cell if needed.

The following may apply for the linked cell and corresponding time resource identified above.

The SBFD pattern determination may be semi-static, or more dynamically determined, with selected time resources, as identified in the previous step. In one example, the WTRU determines the SBFD pattern(s) to use for all the future time resources of the linked cell, until a received (re) configuration or a new dynamic determination changes it. For instance, if the reference cell has a constant TDD/SBFD configuration, the corresponding linked cell configuration may also be constant. In another example, the WTRU determines different SBFD pattern for the linked cell for each of the determined time resources, and selects the SBFD pattern based on the reference cells at each of these time resources. For example, the TDD/SBFD directions may be configured using (repeating) patterns and each time resource of the pattern may be different, so the WTRU selects the SBFD configuration according to each time resource of the pattern to match the reference cell(s).

In the case where the WTRU determined that the frequency gap between a reference cell and a linked cell is larger than the relevant threshold, the linked cell is not affected by the reference cell (re) configuration. The WTRU may keep the ongoing duplexing configuration of the linked cell unchanged, for example, either the linked cell may apply its configured default/baseline duplexing configuration, for example, received from the network or an updated configuration based on another reference cell.

In the case where the WTRU determines that the frequency gap between a reference cell and a linked cell is larger than the relevant threshold, and that the linked cell configuration was previously adapted based on that reference cell, the WTRU may revert to the previous update, for example, by applying its configured default/baseline duplexing configuration (e.g., received from the network or an updated configuration based on another reference cell).

For the linked cells and the corresponding time resources whose frequency gap is lower than the threshold with one or more reference cell(s), the WTRU may determine a SBFD configuration for the linked cell(s) and the time resources identified in the previous step, based on the configuration of the reference cell(s).

In an example, the WTRU may be configured with a single SBFD option for each reference cell configuration case. The advantage of using a SBFD pattern for all the time resources is to have either DL or UL available at all instant, improving scheduling flexibility and reducing latency. The WTRU may be configured with the SBFD option that follows the overall principle that “The duplex direction of a subband adjacent to a reference cell is the same as the duplex direction of (adjacent subband of) the reference cell”.

FIG. 5 illustrates examples of SBFD patterns that may be configured to be selected by the linked cell based on a single reference cell. The upper part of the figure shows the case where the reference cell is in a frequency domain above the linked cell while the lower part of the figure shows the case where the reference cell is in a lower frequency. For example, the WTRU received the configuration that for a linked cell with one reference cell in its upper-frequency, when the reference cell is configured in the DL direction or with a DL subband on its common adjacent-side (i.e., using ‘UD’ or ‘DUD’), the WTRU selects the configured ‘DU’ pattern. For example, the WTRU received the configuration that for a linked cell with one reference cell in its upper-frequency, when the reference cell is configured in the UL direction or with a UL subband on its common adjacent-side (i.e., using ‘DU’ or ‘UDU’), the WTRU selects the configured ‘UD’ pattern. For example, the WTRU received the configuration that for a linked cell with one reference cell in its lower-frequency, when the reference cell is configured in the DL direction or with a DL subband on its common adjacent-side (i.e., using ‘DU’ or ‘DUD’), the WTRU selects the configured ‘UD’ pattern. For example, the WTRU received the configuration that for a linked cell with one reference cell in its lower-frequency, when the reference cell is configured in the UL direction or with a UL subband on its common adjacent-side (i.e., using ‘UD’ or ‘UDU’), the WTRU selects the configured ‘DU’ pattern.

FIG. 6 shows examples of SBFD patterns that may be configured to be selected by the linked cell based on two reference cells. If the two reference cells are configured with DL or if their common adjacent SBFD subband is a DL subband, the WTRU selects the ‘DUD’ pattern for the linked cell. If the two reference cells are configured with UL or if their common adjacent SBFD subband is a UL subband, the WTRU selects the ‘UDU’ pattern for the linked cell. If the upper-frequency reference cell is configured with DL, ‘UD’ or ‘DUD’ while the lower-frequency reference cell is configured with UL, ‘UD’ or ‘UDU’, the WTRU may select the ‘DU’ pattern. If the upper-frequency reference cell is configured with UL, ‘UD’ or ‘UDU’ while the lower-frequency reference cell is configured with DL, ‘UD’ or ‘DUD’, the WTRU may select the ‘UD’ pattern.

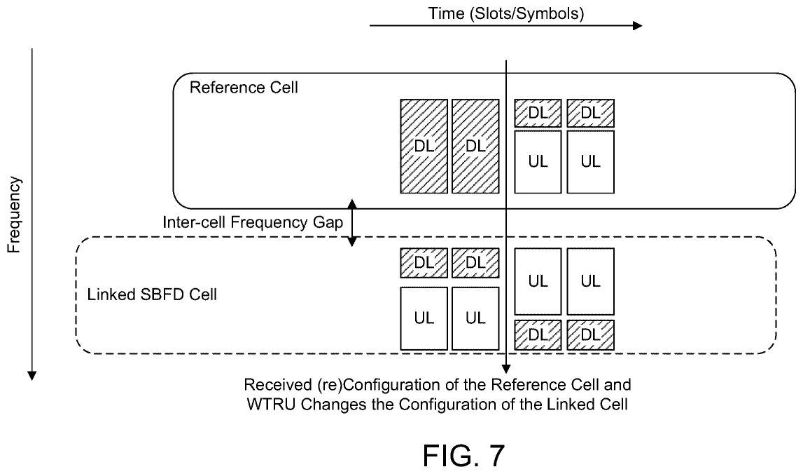

FIG. 7 illustrates an exemplary timeline where a WTRU changes its linked cell SBFD configuration based on the reference cell. As shown in FIG. 7, the WTRU is originally configured with a reference cell in downlink and its linked cell as ‘DU’ (either as a baseline or as already adapted based on the reference cell). The WTRU receives the (re) configuration of the reference cell indicating a DU configuration. The WTRU, if all the conditions are met, determines the linked cell configuration (e.g., based on the allowed set of configurations in FIG. 5), and selects the UD pattern for the linked cell.

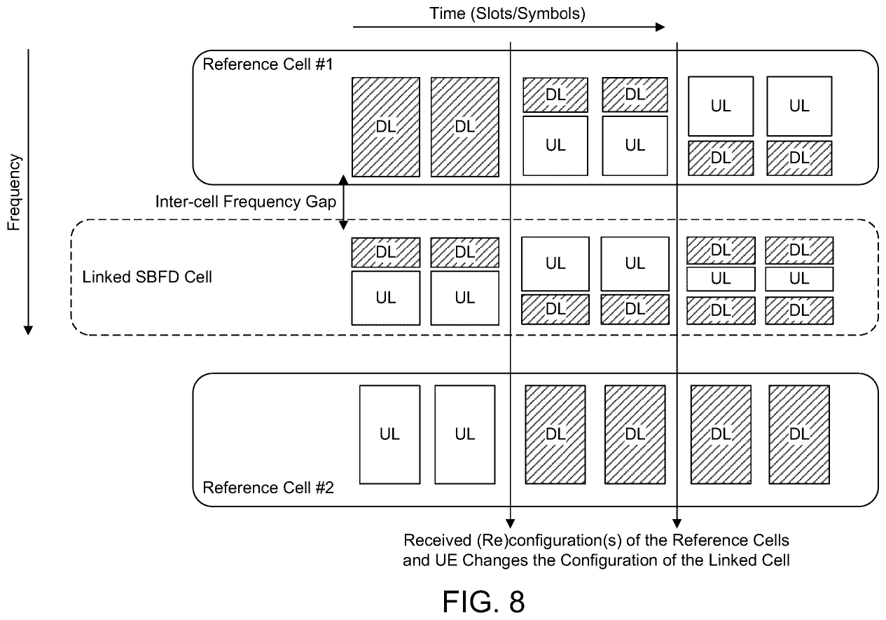

FIG. 8 provides an example where a WTRU is configured with a linked cell that is associated with two reference cells and shows the reception of two reference cell reconfiguration. The first reconfiguration updated both reference cells and the selects a SBFD pattern matching the reference cells (e.g., based on FIG. 6). The second reconfiguration received only changes one of the reference cell, but the WTRU considers both reference cell configuration to select the SBFD pattern matching the reference cells (e.g., the DUD in this example).

In the situation where the linked cell does not have a reference cell, for example, due to large frequency gaps with potential reference cells, the WTRU may apply a configured default configuration and/or keep the previous configuration unchanged. In the situation where the WTRU is not configured with a SBFD pattern for its current situation (e.g. number and position of reference cells compared to the linked cell, etc.), the WTRU may fall back to a non-SBFD configuration.

In the embodiments described above, the WTRU may determine the SBFD pattern of a given time resource based on the configuration of the reference cell, and the SBFD pattern includes the subband directions and configuration for the whole configured bandwidth—in other words, the WTRU replaces the existing (e.g. default/baseline/current) duplexing configuration with another configuration. In an alternative/complementary solution, the WTRU may be configured to update a part of its SBFD configuration, for example, to only modify the subband of the linked cell that is adjacent to the reference cell, and so it keeps the other already configured subbands (the ones not adjacent to the reference cell) unchanged.

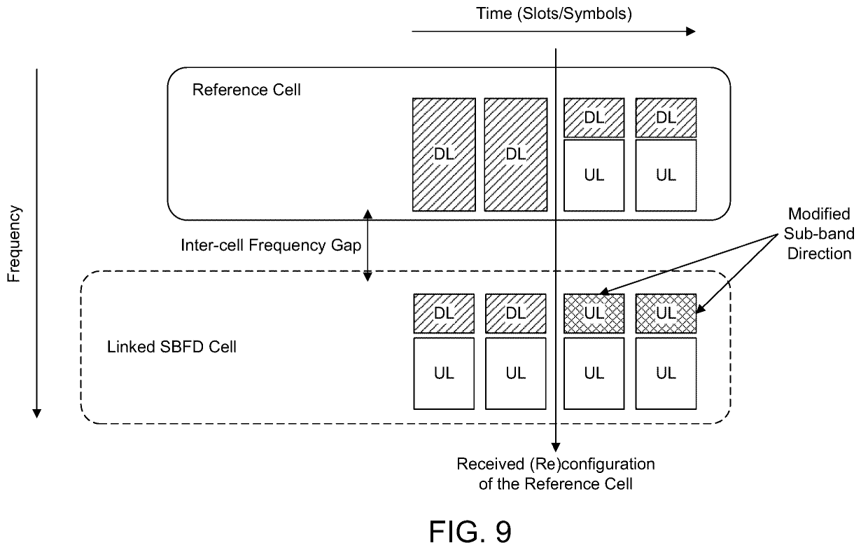

FIG. 9 illustrates examples of a WTRU changing a subband based on a reference cell reconfiguration. In one example, the linked cell is configured on a time resource with a SBFD configuration, and receives the indication of the TDD/SBFD configuration for that time resource, and where the frequency gap between the cells is higher than the threshold.

If a linked cell is configured as ‘DU’ or ‘DUD’ and the reference cell is in the upper-frequency (re) configured with ‘DU’, ‘UDU’ or Uplink, the linked cell may change the direction of the upper downlink subband to be Uplink, reconfiguring its linked cell to, respectively, only ‘Uplink’ or ‘UD’

If a linked cell is configured as ‘UD’ or ‘UDU’ and the reference cell is in the upper-frequency (re) configured with ‘UD’, ‘DUD’ or Downlink, the linked cell may change the direction of the upper Uplink subband to be Downlink, reconfiguring its linked cell to, respectively, only ‘Downlink’ or ‘DU’.

If a linked cell is configured as ‘UD’ or ‘DUD’ and the reference cell is in the lower-frequency (re) configured with ‘UD’, ‘UDU’ or Uplink, the linked cell may change the direction of the lower downlink subband to be Uplink, reconfiguring its linked cell to, respectively, only ‘Uplink’ or ‘DU’.

If a linked cell is configured as ‘DU’ or ‘UDU’ and the reference cell is in the lower-frequency (re) configured with ‘DU’, ‘DUD’ or Downlink, the linked cell may change the direction of the lower Uplink subband to be Downlink, reconfiguring its linked cell to, respectively, only ‘Downlink’ or ‘UD’.

Note, that when the WTRU changes the direction of a subband of a SBFD pattern (e.g., from ‘DUD’ to ‘UUD’, from ‘UD’ to ‘UU’, from ‘DU’ to ‘DD’, etc.) two adjacent subbands becomes configured in the same direction, and can effectively be considered by the WTRU either as a single merged subband (e.g., UUD becomes UD, DDU becomes DU, UU becomes Uplink, etc.), or as two separated subband, for example, to keep the inter-subband guard-band, if any.

In an embodiment, a WTRU may transmit one or more reports and/or indications to indicate the determined changes in the direction of configured SBFD subbands. For example, the WTRU may trigger sending the report, if received indication on changes in the reference cell's configurations may result in changes in WTRU's configured SBFD. configurations. The report may include one or more information regarding the determined changes. For example, the WTRU may transmit the report to a gNB. In an example, the WTRU may send the report and/or indications via UCI, MAC-CE, and/or RRC signaling.

The indication and/or report may include determined changes. For example, the WTRU may indicate the determined changes based on a flag indication, where a first value (e.g., zero) may indicate a first direction (e.g., UL) and a second flag value (e.g., one) may indicate a second direction (e.g., DL).

The indication and/or report may include a time duration. For example, the WTRU may indicate the time span, during which the WTRU may apply the determined changes. In an example, the WTRU may indicate one or more symbols, slots, and/or frames. for which the WTRU may apply the changes. In another example, the WTRU may indicate the starting time, the time duration, and or the end time. For example, the WTRU may indicate the time duration based on time instances, for example number of symbols, slots, frames, and/or subframes. In another example, the WTRU may indicate the time duration based on time units, for example milliseconds, and/or microseconds.

The indication and/or report may include a frequency resources and/or subbands. For example, the WTRU may indicate the frequency and/or subbands span, for which the WTRU may apply the determined changes. In an example, the WTRU may indicate one or more configured SBFD subbands, where the determined changes may be applied. In another example, the WTRU may indicate the starting frequency, subband, and/or RB, the frequency band, and/or the end and/or last frequency, subband, and/or RB.

The indication and/or report may include periodicity. For example, the WTRU may indicate if applying the determined changes may take place semi-persistently, periodically, or aperiodically. For example, the WTRU may determine the periodicity for applying the changes based on the detected, triggered, and/or determined conditions, for example based on the indicated changes in the reference cell's configuration, as described herein.

In an example, the WTRU may receive configurations, determine, and/or be (pre) configured with time and frequency resources to transmit the report and/or the indications. For example, the WTRU may be configured, indicated, and/or determine to transmit the report before or after applying the determined changes. The WTRU may receive the indication to transmit the report before or after, for example via DCI, MAC-CE, and/or RRC.

The indication may be an indication before applying the determined changes. For example, a WTRU that is operating based on a first direction (e.g., UL or DL) in one or more configured SBFD subbands may determine to apply a second direction (e.g., DL or UL, respectively). In an example, the WTRU that is operating based on DL in a configured SBFD subband may determine to change the direction, for example to UL in the configured SBFD subband.

The WTRU may be (pre) configured, indicated, and/or determine to transmit the report before applying the determined changes as soon as detecting one or more conditions and/or receiving the triggers to change. In an example, the WTRU may determine to transmit the report before applying the change, if there in a long enough time window between detecting the conditions and/or receiving the triggers and applying the required changes. For example, the WTRU may determine that the time window between receiving an indication on changes on the reference cell's configuration and the time to receive or transmit a configured, scheduled, and/or determined UL or DL is longer than a time threshold, wherein the WTRU may determine to transmit the report before applying the changes required based on the indicated changes in the reference cell's configuration.

In an example, the WTRU may be (pre) configured or determine to send the report as part of a (pre) configured CSI report. In another example, the WTRU may transmit a (special) scheduling request (SR), for example via (pre) configured PUCCH resources. As such, the WTRU may transmit the determined changes and corresponding information as part of the transmitted SR.

The indication may be an indication after applying the determined changes. For example, a WTRU that is operating based on a first direction (e.g., UL or DL) may determine to apply a second direction (e.g., DL or UL, respectively). The WTRU may be (pre) configured, indicated, and/or determine to transmit the report after applying the determined changes. For example, the WTRU may transmit the report and/or indication via one or more explicit indications.

The WTRU may send the report as part of UCI and/or MAC-CE associated with the configured and/or scheduled UL transmission. In an example, the WTRU that is scheduled to transmit a PUCCH may include the report as part of the transmitted UCI. In another example, the WTRU that is scheduled to transmit a PUSCH may include the report as part of the transmitted MAC-CE.

The WTRU may send the report as part of HARQ-ACK transmission that is associated with the received indication, indicating the changes in the reference cell's configurations. In an example, the WTRU may transmit an enhanced HARQ-ACK codebook, where the codebook may include a (flag) indication to indicate whether the WTRU has performed the changes. Wherein, a first value (e.g., zero) may indicate no changes are applied, and a second flag value (e.g., one) may indicate that changes are applied.

After receiving the configuration for the reference cell, the WTRU applies the new duplexing configuration on the reference cell.

For the linked cells determined to apply the dynamic SBFD configuration, the WTRU may use the determined/selected SBFD pattern(s) on the identified time resource(s) as previously described. The WTRU may apply the determined configuration on the identified time resource(s) (e.g., based on at least one configured time offset (parameter)) jointly with the (pre) configured duplexing configuration, i.e., where the determined dynamic SBFD configuration is used to override the configuration of the identified time resource(s) or the previously determined dynamic configuration.

On the linked cell, the WTRU may: (1) monitor for DL receptions on the DL subbands of the selected SBFD patterns, and for the corresponding time resources, such as PDCCH monitoring, PDSCH reception, and/or SSBs and (2) perform UL transmissions on the UL subbands of the selected SBFD patterns, and for the corresponding time resources, such as PUCCH, PUSCH, RACH etc., based on received or configured grants and resources.

In one example, the WTRU may be (pre) configured with a timer or duration, and the WTRU may wait that configured duration (or trigger the timer when receiving the indication changing the SBFD configuration of the linked cell and wait for timer expiration) to apply the determined SBFD pattern.

In another example, the WTRU may be (pre) configured to perform a handshake with the network before applying the determined SBFD pattern(s), in which case the WTRU may, after determining the SBFD patterns and the corresponding time resources, indicate these to the network and wait for feedback (e.g., acknowledgment) from the network to apply the configuration (e.g., after a pre-defined or configured time offset after the acknowledgement).

In one embodiment, dynamic subband duplexing configurations as a function of the adjacent cell configuration may be provided.

A WTRU may receive a (pre) configuration for multiple serving cells including a configuration for each cell and a multi-cell duplexing configuration. For each cell, the configuration may include the frequency position and width of the cell carrier and the duplexing (TDD/SBFD) configuration for each time resource (slot or symbol), and may be one of: UL, DL, flexible, SBFD, and/or flexible SBFD. In a flexible configuration, the system may dynamically (and/or flexibly) change/adjust/switch the communication direction. The multi-cell duplexing configuration information may include an indication that one or more cells are reference cell(s) for duplexing configuration (e.g., by cell ID and/or frequency) (e.g., a Pcell). The multi-cell duplexing configuration information may include an indication that one SBFD cell is a linked cell (e.g., by cell ID and/or frequency) (e.g., a Scell). The multi-cell duplexing configuration information may also include an inter-cell frequency gap threshold.

The WTRU may receive an indication from the network of a (re) configuration of the duplexing configuration of the reference cell(s) on some time resource(s). Time resource(s) may include at least the time resources being configured as flexible, SBFD or flexible SBFD in the linked cell. The (re) configuration may be conditional on the frequency gap between the reference cell and the linked cell being less that the configured threshold. The indication may be in the form of an RRC, a MAC, or DCI signaling (e.g., received from the reference cell).

The WTRU may determines the SBFD configuration of the linked cell for the time resource(s), based on the received reference cell duplexing configuration. For example, the SBFD configuration may include the number of subbands (e.g. 2 or 3) and their duplex direction (e.g., DL or UL). The duplex direction of a subband of the linked cell adjacent (in frequency) to a reference cell may be the same as the duplex direction of the reference cell. If the reference cell is not configured with SBFD for the indicated time resource, there may be one link direction for the reference cell.

The WTRU may apply the new configuration on the linked cell, including, for example, monitoring DL on the DL subbands in the corresponding time resources and performing UL transmissions on the UL subband in the corresponding time resources.

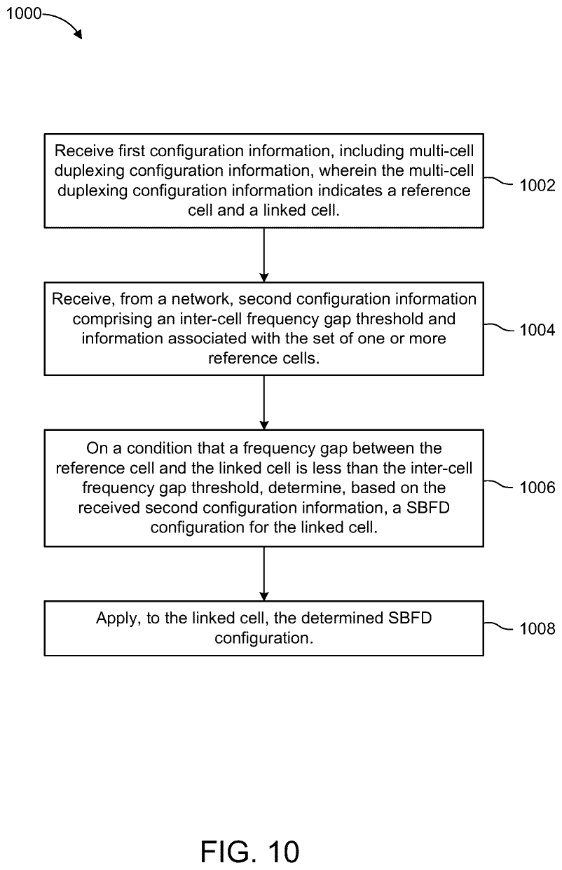

FIG. 10 is a flowchart illustrating an exemplary procedure performed by a WTRU. At 1002, the WTRU may receive first configuration information, including multi-cell duplexing configuration information, wherein the multi-cell duplexing configuration information indicates a first reference cell and a linked cell. The first reference cell may be included in a set of one or more reference cells. At 1004, the WTRU may receive, from a network, second configuration information comprising an inter-cell frequency gap threshold and information associated with the set of one or more reference cells. At 1006, the WTRU may, on a condition that a frequency gap between the reference cell and the linked cell is less than inter-cell frequency gap threshold, determine, based on the received second configuration information, a SBFD configuration for the linked cell. At 1008, the WTRU may apply, to the linked cell, the determined SBFD configuration.

In another embodiment, an WTRU may be (pre) configured with multiple possible SBFD configurations for the linked cells, and the WTRU determines a subset of these configurations based on the configuration of the reference cell(s). The WTRU may further receive an indication from the network indicating which of the configuration to use, from the remaining possibilities.

Having multiple possible configurations for each reference cells gives the network and WTRU flexibility in the SBFD configurations. The flexibility may be given as different SBFD patterns—as long as they are aligned with the reference cell, for example if the upper-frequency reference cell is Downlink, the WTRU may use Downlink, DU or DUD. Another flexibility is that the WTRU may be configured with multiple versions of a same SBFD pattern, for example, with different subbands sizes and positions. For instance, one DU may be configured with 5 RBs for the DL subband and 10 RBs for the UL subband; another DU may be configured with 10 RBs for the DL subband and 5 RBs for the UL subband, or any split of the resources of the cells between the subbands, including potential guard-bands.

In a first example, the WTRU receives multiple possible SBFD configurations for the linked cell, for each combination of reference cell(s) configuration. Each of the configuration may be indexed or listed in a specific order that the network can further send as a reference.

For example, assuming a single frequency-adjacent reference cell in the upper-frequency, if the reference is configured to with a DL cell or a DL subband in its lower-frequency edge (e.g., UD, DUD), the set of configurations for the linked cell may be, for example: one or more SBFD DU configuration(s) (e.g., with different subband splits); one or more SBFD DUD configuration(s) (e.g., with different subband splits); and/or a non-SBFD DL configuration. If the reference is configured to with a UL cell or a UL subband in its lower-frequency edge (e.g., DU, UDU), the set of configurations for the linked cell may be, for example: one or more SBFD UD configuration(s) (e.g., with different subband splits); one or more SBFD UDU configuration(s) (e.g., with different subband splits); and/or a non-SBFD UL configuration.

For example, assuming a single frequency-adjacent reference cell in the lower-frequency, if the reference is configured to with a DL cell or a DL subband in its upper-frequency edge (e.g., DU, DUD), the set of configurations for the linked cell may be, for example: one or more SBFD UD configuration(s) (e.g., with different subband splits); one or more SBFD DUD configuration(s) (e.g., with different subband splits); and/or a non-SBFD DL configuration. If the reference is configured to with a UL cell or a UL subband in its upper-frequency edge (e.g., UD, UDU), the set of configurations for the linked cell is, for example: one or more SBFD DU configuration(s) (e.g., with different subband splits); one or more SBFD UDU configuration(s) (e.g., with different subband splits); and/or a non-SBFD UL configuration.

Assuming a linked cell surrounded by two frequency-adjacent reference cells, when both reference cells are configured with a DL direction, the linked SBFD cell may be configured with, for example, one or more ‘DUD’ configurations, (e.g., with different subband splits) and/or a non-SBFD DL configuration. When both reference cells are configured with a UL direction, the linked SBFD cell may be configured with, for example, one or more ‘UDU’ configurations, (e.g., with different subband splits) and/or a non-SBFD UL configuration. When one reference cells is configured with a DL direction, and the other one is configured as a UL direction, the linked SBFD cell is configured with one or more ‘DU’ or ‘UD’ configurations (e.g., with different subband splits), where the DL subband is on the side of the linked cell adjacent to the DL reference cell and the UL subband is on the side of the linked cell adjacent to the UL reference cell.

In another embodiment, the WTRU may receive a set of possible SBFD configurations for the linked cell without direct association with reference cell(s) configuration. For example, the WTRU receives a set of SBFD configurations including one or more of ‘DU’, ‘UD’, ‘DUD’, ‘UDU’, ‘D’, ‘U’ patterns, and, possibly, multiple configurations of a given pattern (e.g., using different sizes and positions of the subbands).

The WTRU, when receiving the indication from the network of a (re) configuration of the duplexing configuration of a reference cell, and in addition to the actions described in the previous section, further determines the subset of SBFD configuration applicable for the different time resources, based on the received indication.

In one example, the WTRU may check the configuration of the reference cell(s) of a linked cell and determines the subset of SBFD configuration applicable to the configuration of the reference cell(s). The WTRU may, as described previously, consider as reference cell(s) cells based on whether the frequency gap between the cells is larger than the configured threshold(s).

In another example, the WTRU may determine a subset of the SBFD configurations that are still valid given the reference cells configuration. For instance, the direction of the duplexing configuration of the reference cell(s) must be the same at the common edges of the cells. Also, the WTRU may check the frequency gap between opposite direction subbands of the SBFD configuration set and the reference cells. If the frequency gap between opposite directions is below a configured threshold (e.g., received by the WTRU from the network jointly with the dynamic SBFD configurations), then the configuration is not valid. The WTRU determines the set of remaining valid SBFD configuration for each time resources.

In both examples above, the frequency gap verification may consider, as previously described, different frequency reference, such as the subbands edges, cell edges or BWP edges.

The WTRU may then receive an indication from the network indicating which of the remaining subset of SBFD configurations the WTRU may apply. Given the configured conditions to down-select the subset of configurations, the WTRU and network are able to have a shared understanding of the remaining subset of SBFD configurations for a given linked and reference cell conditions, thus the network can send an index in the subset of configuration, and the WTRU, receiving the index, identifies the subset to use. The index may be indicated using a field of length size being the log 2 of the subset size (rounded up), for each different combination of the reference cells.

In one example, the WTRU receives a time pattern indicating the list of SBFD patterns, from the remaining subsets, to apply for each time resource of the pattern, for example, following the TDD-UL-DL configuration patterns. This way gives full flexibility of configuring time resources individually.

In another example, the WTRU may receive, for each configured combination of the reference cell(s), the index of the corresponding linked cell SBFD pattern (e.g., reference cell #1 use SBFD pattern #2, reference cell #2 use SBFD pattern #1, etc.) and the WTRU may apply the SBFD pattern on the difference time resources of the linked cell for each corresponding reference cell combination.

The above described methods of configuring the relation between reference cell configuration and linked cell configuration may be signaled after each reference cell (re) configuration, or signaled once and kept applicable until this is re-signaled (i.e., the WTRU receiving reference cell reconfiguration keeps applying the previously received reference cell-linked cell mapping).

In one example, the WTRU may receive the indication using RRC reconfiguration or MAC signaling, which may be jointly signaled with the reference cell (re) configuration.

In another example, the WTRU receives the indication using a DCI indication, where a field indicates the index of the subset of SBFD configurations to use. In another example, the index may be implicitly determined based on at least one parameter (e.g., DCI format, DL or UL grant, an existing field value(s), RNTI, etc.) of the received DCI. The WTRU may use the received index for the corresponding assigned time resource indicated in the DCI (e.g., for DL or UL grants), and the WTRU may use the pattern for the time resources and/or reference cell combination similar to the one indicated in the DCI.

Similarly to above, the WTRU may further apply the configuration to receive and transmit on the corresponding UL and DL subbands.

In one embodiment, a WTRU may determine a subset of SBFD configurations of a cell based on the reference cell configuration.

A WTRU may receive a (pre) configuration for multiple serving cells including a configuration for each cell and a multi-cell duplexing configuration. For each cell, the configuration may include the frequency position and width of the cell carrier and the duplexing (TDD/SBFD) configuration for each time resource (slot or symbol), and may be one of: UL, DL, flexible, SBFD, and/or flexible SBFD. In a flexible configuration, the system may dynamically (and/or flexibly) change/adjust/switch the communication direction. The multi-cell duplexing configuration information may include an indication that one or more cells are reference cell(s) for duplexing configuration (e.g., by cell ID and/or frequency) (e.g., a Pcell). The multi-cell duplexing configuration information may include an indication that one SBFD cell is a linked cell (e.g., by cell ID and/or frequency) (e.g., a Scell). The multi-cell duplexing configuration information may also include an inter-cell frequency gap threshold. The (pre) configuration may also include a set of SBFD configurations for linked cells, including the frequency position and width of each subbands and its directions, for each time resources. The configuration may be associated with a given configuration of reference cell(s).

The WTRU may receive an indication from the network of a (re) configuration of the duplexing configuration of the reference cell(s) on some time resource(s). Time resource(s) may include at least the time resources being configured as flexible, SBFD or flexible SBFD in the linked cell. The (re) configuration may be conditional on the frequency gap between the reference cell and the linked cell being less that the configured threshold. The indication may be in the form of an RRC, a MAC, or DCI signaling (e.g., received from the reference cell).

The WTRU may determine a subset of the SBFD configurations for the linked cell for the time resource(s), based on the received reference cell duplexing configuration. For example, the subset of the SBFD configurations may include the subset of configurations associated to the configuration reference cell(s) and/or the subset of configurations for which the opposed direction subbands are beyond a frequency gap threshold.

The WTRU may receive an indication from the network indicating which of the subset of configuration to apply (e.g., an index subset of SBFD configuration). The indication may be received via DCI, MAC or RRC signaling.

The WTRU may apply the new configuration on the linked cell, including, for example, monitoring DL on the DL subbands in the corresponding time resources and performing UL transmissions on the UL subband in the corresponding time resources.

In the previously described embodiments, a WTRU may receive an explicit configuration of reference cells, and deduces an implicit configuration of the linked cell. In an alternative or complementary embodiment, the WTRU may be configured with multi-cell duplexing configuration, where a configuration explicitly applies to the different cells and can be jointly configured/sent to reduce signaling overhead and improve inter-cell alignment configuration, without linked/reference cells.

In an embodiment, the WTRU may receive a configuration of the TDD/SBFD (e.g., IBFD, at least partially overlapped SB-FD) configuration of multiple configured cells. Each cell may be configured, for different time resources, with SBFD or non-SBFD duplexing configuration, including UL, DL, DU, UD, DUD, UDU and Flexible, for example, using a constant time configuration or using a time pattern similar to the TDD-UL-DL configuration patterns.

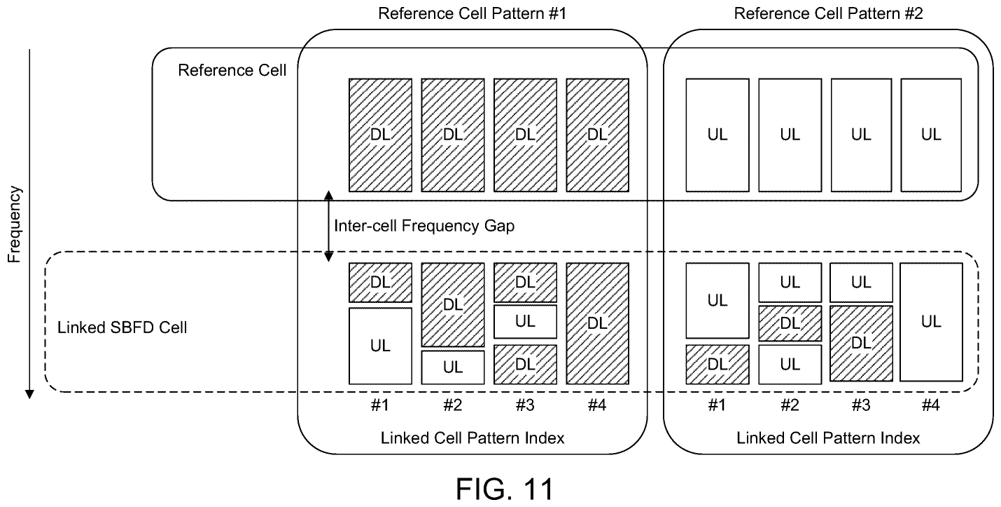

FIG. 11 illustrates example of sets of linked cell SBFD configurations listed for different reference cells configuration. As shown in FIG. 11, in one example, the WTRU may be configured with one configuration for each duplexing direction/pattern for example, UL, DL, DU, UD, DUD, UDU and Flexible. The WTRU may be configured with a duplexing configuration combination for a multi-cell configuration, for example, [UL, UD, DL] corresponds to having 3 cells where the first cell is configured to UL, the second to UD and the third to DL. The WTRU may be configured with an indexed set of these duplexing configuration combinations, e.g., [[DL, DU, UL], [UD, DU, UD], [DL, DL, DL], . . . ]. The WTRU then receives the indication, for the different time resources, of which combination (e.g., the combination number 2) to apply, so that a single configuration enables the configuration of multiple cells at once.

In one example, the WTRU is configured with an index set of duplexing (TDD/SBFD) configurations, which may include one or more or each of [UL, DL, DU, UD, DUD, UDU and Flexible], for example, with difference subband sizes. The WTRU is configured with an index set of these duplexing configuration combinations, where the duplexing combination is based on the index duplexing configuration, for example [[4, 2, 4], [1, 1, 4], [3, 1, 2], . . . ]. The WTRU may receive the indication of which combination to use for the different time resources, for example, in case of combination #2, the WTRU applies the multi-cell configuration where the first and second cell applies the duplexing configuration #1 and the third cell applies the configuration #3.

In one example, the WTRU may receive an indication of the cells that are configured in the multi-cell configuration, for example, for 3 cells, the WTRU may receive an indication that the configuration applies to [cell 1, cell 4, cell 2], in the same order as the configuration of the duplexing configuration combinations. The cells may be identified by their cell ID and/or frequency. This way, the WTRU knows the mapping between the configuration and the corresponding cells and when receiving the combination index, can apply the corresponding duplexing configuration to the corresponding cell.

In one example, the WTRU may receive the duplexing configurations and combinations of duplexing configurations using RRC or MAC signaling. The WTRU may further receive subsets of “active” these configurations or combinations, for example, via MAC or RRC signaling, to reduce the number of configuration and signaling.

In one example, the WTRU may receive the indication of which combination to apply for the different time resources using RRC, MAC or DCI signaling. Similarly as above, the WTRU may further apply the configuration to receive and transmit on the corresponding UL and DL subbands.

In an embodiment, a WTRU may receive a (pre) configuration for multiple serving cells including. The (pre) configuration may include a list of multi-cell duplexing configuration patterns, indicating for each pattern, the duplexing direction of each cells. The duplexing direction may be UL, DL, Flexible, SBFD (DU), SBFD (UD), and/or SBFD (DUD). For example, the duplexing direction may be [[DL, UL, DL], [DL, DL, DL], [UL, SBFD (UD), DL], . . . ] for 3 configured cells. The (pre) configuration may include the order of the cells in the patterns (e.g., reference by cell ID and/or frequency). For example, the order of the cells may be [cell #1, cell #2, cell #3] for 3 configured cells. The WTRU may optionally receive an indication (e.g., via RRC or MAC signalling), of a subset of the list.

The WTRU may receive an indication, from the network (e.g., via RRC, MAC, or DCI signalling), a list of indices from the list of multi-cell duplexing patterns and the associated slot and/or symbols. The WTRU may then determine, for each cell in the multi-cell duplexing configuration, the duplexing configuration for the indicated slots and symbols, based on the received indices from the list of patterns, the cell position in the pattern and the (subset of the) list of multi-cell duplexing configuration pattern. The WTRU may apply the new configuration on the linked cell, including, for example, monitoring DL on the DL subbands in the corresponding time resources and performing UL transmissions on the UL subband in the corresponding time resources.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

What is claimed:

1. A method performed by a wireless transmit/receive unit (WTRU), the method comprising:
receiving first configuration information, including multi-cell duplexing configuration information, wherein the multi-cell duplexing configuration information indicates a first reference cell and a linked cell, wherein the first reference cell is included in a set of one or more reference cells;
receiving, from a network, second configuration information comprising an inter-cell frequency gap threshold and information associated with the set of one or more reference cells;
on a condition that a frequency gap between the reference cell and the linked cell is less than the inter-cell frequency gap threshold, determining, based on the received second configuration information, a subband non-overlapping full duplex (SBFD) configuration for the linked cell; and
applying, to the linked cell, the determined SBFD configuration.

2. The method of claim 1, wherein the first configuration information further includes at least one of:
duplexing information for all time resources associated with the reference cell and the linked cell; or
frequency information associated with the reference cell and the linked cell.

3. The method of claim 2, wherein the frequency information includes at least one of a frequency position and size of a carrier, subband, or bandwidth part.

4. The method of claim 1, wherein the second configuration information includes at least one of:
duplexing information for one or more time resources associated with the reference cell; or
frequency information associated with the reference cell.

5. The method of claim 1, wherein the second configuration information includes an indication of time resources to be configured in the reference cell, including duplexing directions.

6. The method of claim 5, wherein the determination of the SBFD configuration for the linked cell is for the time resources is included in the second configuration information.

7. The method of claim 5, wherein the time resources of the linked cell are configured as flexible, SBFD, or flexible SBFD.

8. The method of claim 5, wherein applying the determined SBFD configuration includes at least one of:
performing uplink transmissions on an uplink subband in the time resources indicated in the second configuration information; or
monitoring downlink transmissions on an downlink subband in the time resources indicated in the second configuration information.

9. The method of claim 1, wherein the determined SBFD configuration includes a number of subbands and a duplex direction for each subband.

10. The method of claim 9, wherein the duplex direction for the subband adjacent to the reference cell is the same as a duplex direction of the reference cell.

11. A wireless transmit/receive unit (WTRU) comprising:
a transceiver; and
a processor;
wherein the transceiver and processor are configured to:
receive first configuration information, including multi-cell duplexing configuration information, wherein the multi-cell duplexing configuration information indicates a first reference cell and a linked cell, wherein the first reference cell is included in a set of one or more reference cells;
receive, from a network, second configuration information comprising an inter-cell frequency gap threshold and information associated with the set of one or more reference cells;
on a condition that a frequency gap between the reference cell and the linked cell is less than the inter-cell frequency gap threshold, determine, based on the received second configuration information, a subband non-overlapping full duplex (SBFD) configuration for the linked cell; and
apply, to the linked cell, the determined SBFD configuration.

12. The WTRU of claim 11, wherein the first configuration information further includes at least one of:
duplexing information for all time resources associated with the reference cell and the linked cell; or
frequency information associated with the reference cell and the linked cell.

13. The WTRU of claim 12, wherein the frequency information includes at least one of a frequency position and size of a carrier, subband, or bandwidth part.

14. The WTRU of claim 11, wherein the second configuration information includes at least one of:
duplexing information for one or more time resources associated with the reference cell; or
frequency information associated with the reference cell.

15. The WTRU of claim 11, wherein the second configuration information includes an indication of time resources to be configured in the reference cell, including duplexing directions.

16. The WTRU of claim 15, wherein the determination of the SBFD configuration for the linked cell is for the time resources included in the second configuration information.

17. The WTRU of claim 15, wherein the time resources of the linked cell are configured as flexible, SBFD, or flexible SBFD.

18. The WTRU of claim 15, wherein applying the determined SBFD configuration includes at least one of:
performing uplink transmissions on an uplink subband in the time resources indicated in the second configuration information;
monitoring downlink transmissions on an downlink subband in the time resources indicated in the second configuration information.

19. The WTRU of claim 11, wherein the determined SBFD configuration includes a number of subbands and a duplex direction for each subband.

20. The WTRU of claim 19, wherein the duplex direction for the subband adjacent to the reference cell is the same as a duplex direction of the reference cell.
